(19) United States
(12) Patent Application Publication
(10) Pub. No.: US 2025/0094855 A1
(43) Pub. Date: Mar. 20, 2025

(54) OPTIMAL DATA-DRIVEN DECISION-MAKING IN MULTI-AGENT SYSTEMS

(71) Applicant: University of Washington, Seattle, WA (US)

(72) Inventors: Benjamin Chasnov, Seattle, WA (US); Lillian Ratliff, Seattle, WA (US); Samuel A Burden, Seattle, WA (US); Amy Orsborn, Seattle, WA (US); Tanner Fiez, Seattle, WA (US); Manchali Maneeshika Madduri, Seattle, WA (US); Joseph G Sullivan, Seattle, WA (US); Momona Yamagami, Seattle, WA (US)

(73) Assignee: University of Washington, Seattle, WA (US)

(21) Appl. No.: 18/290,707

(22) PCT Filed: Jul. 20, 2022
(86) PCT No.: PCT/US2022/037763

§ 371 Date: Jan. 19, 2024

Related U.S. Application Data
(60) Provisional application No. 63/224,325, filed on Jul. 21, 2021.

(51) Int. Cl. G06N 20/00; G06F 3/01

(52) U.S. Cl. CPC G06N 20/00; G06F 3/015

(57) ABSTRACT

Systems and methods for optimizing data-driven decision-making in multi-agent systems are described. The system may construct an equilibrium concept to capture multi-layer and/or k-level depth reasoning by agents. The system may determine best-response type conjectures for agents to interact with one another. In some examples, the system may include a machine or an algorithm interacting with a strategic agent (e.g., a human or an entity). The system may include methods for: (1) data-driven estimation and/or learning of conjectures and associated depth; and (2) data-driven design of algorithmic mechanisms for exploring the conjectural equilibrium (CE) space by influencing the strategic agent(s) behaviors through adaptively adjusting and estimating deployed strategies.

### CROSS-REFERENCE TO RELATED APPLICATION

The present application claims the benefit of U.S. Provisional Patent Application No. 63/224,325, filed on Jul. 21, 2021, which is incorporated herein by reference in its entirety as if fully set forth herein.

### STATEMENT REGARDING FEDERALLY SPONSORED RESEARCH OR DEVELOPMENT

This invention was made with government support under Grant No. T90 DA032436, awarded by the National Institutes of Health and Grant No. 1836819, awarded by the National Science Foundation, and Grant No. N000142012571, awarded by the Office of Naval Research. The government has certain rights in the invention.

### BACKGROUND

Game theory provides various framework for modeling interactions between two or more players (also referred to herein as “agents”). In particular, the two or more players may strategically make decisions to interact with each other. In a traditional two-player zero-sum game, any gain or loss of a first player is balanced by those of a second player. A topic of study in game theory may include equilibrium analysis based on a concept of mixed-strategy equilibria for the two-player zero-sum game.

In an example non-cooperative game theory, the system may apply an equilibrium concept (e.g., Nash equilibrium) to characterize the outcome of rational players and optimize individual cost functions that depend on the actions of competitors. In the present example game theory, the system may determine the equilibrium concept based on the assumption that no player has an incentive to unilaterally deviate from the candidate equilibrium strategy.

In additional and/or alternative examples, the system may include a player that is not fully rational. For example, the player may disproportionately weight probabilities of events or outcomes that are distorted based on the individual perceptions of values. In some examples, the player may be boundedly rational due to computational limitations. The computational limitations may be demonstrated in modern artificial intelligence (AI) systems, which include (1) humans interacting with machines or algorithms and (2) algorithms interacting with algorithms. Machines and algorithms may be boundedly rational by nature. While humans, being risk-sensitive, may overvalue rare events with perceived catastrophic consequences and undervalue commonly occurring events.

Traditionally bounded rationality models and behavioral models from economics and behavioral psychology have disadvantages, including models that are difficult to compute or not computationally tractable. Moreover, the models applied to humans may not be experimentally validated except on small-scale and largely static tasks.

An example equilibrium predating Nash equilibrium includes conjectural variations equilibrium concept. The conjectural variations equilibrium incorporates the idea that a first player is formulating a conjecture about a second player (“the opponent”) and the opponent's reasoning and strategic reactions. Within the context of the current disclosure, a “conjectural variation” may refer to a belief that the first player has an idea about a reaction of the opponent if the first player performs an action. A challenge with the present example equilibrium is that the first player's conjectures about the opponent may not produce the same equilibrium strategy dictated by the opponent's actual behavior. For instance, the first player's conjectures about the second player may not be consistent with actual plays. Accordingly, the system may include examples of “consistency” to account for the difference between conjectures and actual plays to formulate a consistent conjectural variations equilibrium (CCVE). However, the present equilibrium concept may still present challenges from computational tractability and equilibrium conditions leading to coupled partial differential equations, in which equilibrium strategies, even for simple games, are functional.

### SUMMARY OF THE DISCLOSURE

The present disclosure provides systems and methods for a multi-agent conjectural system configured to use observed data to learn and optimize conjectures. The conjectures may determine how an agent reasons with respect to another agent in a strategic environment. In some examples, the system may construct an equilibrium concept to determine multi-layer or k-level depth reasoning by agents. In various examples, the system may determine “best-response” type conjectures for agents interacting with one another. The “best response” may be defined by minimizing cost and/or domain objectives.

### BRIEF DESCRIPTION OF THE DRAWINGS

FIG. 1 illustrates an example system including a multi-agent conjectural system configured to optimize interactions between example machine first agents and example human user second agents.

FIG. 2 is a block diagram of an illustrative computing architecture of the computing device(s) shown in FIG. 1.

FIG. 3 illustrates an example implementation of components and models that may be configured to be used with a multi-agent conjectural system, as described herein.

FIG. 4 illustrates an example of data mapping for the decision landscape of agents in a scalar quadratic game.

FIG. 5 illustrates an example process for a multi-agent conjectural system to optimize decision-making for a first agent.

FIG. 6 illustrates another example process for a multi-agent conjectural system to optimize decision-making for a first agent.

FIG. 7 illustrates another example process for a multi-agent conjectural system to optimize decision-making for a first agent.

FIG. 8 illustrates another example process for a multi-agent conjectural system to optimize decision-making for a first agent.

FIG. 9 illustrates another example process for a multi-agent conjectural system to optimize decision-making with objectives.

FIG. 10 illustrates an example process for a multi-agent conjectural system to learn conjectures.

FIG. 11 illustrates an example process for a multi-agent conjectural system to synthesize optimal interactions between agents.

### DETAILED DESCRIPTION

The present disclosure provides systems and methods for a multi-agent conjectural system that is configured to generate conjecture models using observed data to capture multi-layer reasoning by agents. The system may include methods for: (1) data-driven estimation and/or learning of conjectures and associated depth; and (2) data-driven design of algorithmic mechanisms for exploring the conjectural equilibrium (CE) space by influencing the strategic second agent(s) behaviors through adaptively adjusting and estimating deployed strategies.

In some examples, the system may determine differential bounded rationality that allows continual learning processes and wherein human agents interact with machines (“human-machine”) or machines interact with machines (“machine-machine”). The system may be applied to both human-machine and machine-machine for repeated competitive interactions and dynamic competitive interactions. In various examples, the differential bounded rationality for a specific area domain may be defined by a domain designer. For instance, a domain expert may define a set of input parameters and output objectives for a device.

Within the context of the current disclosure, a “game” between n agents can be defined by:
the set of players indexed by [symbol] ={1, . . . , n},
the action or strategy (the “action or strategy” may be referred to herein as the “action”) space of each player, namely Xᵢ for each i∈ [symbol] the system denotes the joint action space by X=X₁× . . . ×Xₙ, and
the cost function of each player, namely ƒᵢ:X→ [symbol] .
   An individual agent may seek to minimize its cost ƒᵢ with respect to its choice variable xᵢ. The cost function of agent i may depend on other agents' actions xⱼ∈ [symbol] \{i}. The system may use the notation x₋ᵢ=(x₁, . . . , xᵢ₋₁, xᵢ₊₁, . . . , xₙ) for all the actions excluding xᵢ. In some examples, the present methods and systems can be applied to dynamic games, including an environment in which the agents are interacting. The environment may include changes over time and may include definitions of states on which individual player costs may depend.

It is to be appreciated that although the instant application includes many examples and illustrations of games as interactions between two players in a common environment, the present system may be configured to be used with games between any number of players. In particular, the use of the system for a two-player continuous game is a non-limiting example of how the present system can be used to optimize decision-making and conjectures from a first agent interacting with a second agent. In the present example, the two-player continuous game may be between a human (“second agent”) and a machine (“first agent”), wherein the agents have associated costs to minimize. A player i's cost function ƒᵢ may depend on actions x₋ᵢ of other agents, and the player i may determine conjectures with respect to how opponents will react to its choice xᵢ.

In various examples, a conjecture may be determined by mapping from (1) action spaces to action spaces or (2) cost functions to action spaces. The present system may elect to use conjectures that include mappings from action spaces to action spaces to enable a data-driven continual learning process.

Within the context of the current disclosure, an agent is “boundedly rational” or of bounded rationality if the degree to which it is rational is bounded. In some examples, the system describes an agent seeking to suffice rather than optimize. However, the “boundedly rational” agent decision problems may still be formulated as optimization problems, wherein the degree of rationality is encoded in the optimization problem. The system presumes human decision-makers are bounded rationality due to a number of factors, including the time frame in which the decision must be made, the cognitive facilities of the human (which may vary from person to person), and the difficulty of the decision problem. The system may also presume machines are equally of bounded rationality due to the fact that machines have, by their very nature, limited computational capacity.

In a non-limiting example, the system may define a two-agent game as including a “device” as a first agent and a “human user” (or “operator”) as a second agent. In the present example, the system may include a general objective to minimize the cost associated with the actions of the device and may also presume that the human user has a similar objective to minimize the cost associated with the actions of the human user. In some examples, the system is presumed to “know” a cost function (e.g., received a predefined cost function) associated with the actions of the device and may “know” actions of the human user based on observations but does not know the cost function associated with the user. Thus, the system may include an objective to estimate the cost function of the human user by using observation data to generate a cost model for the human user. By determining that the human user may want to minimize cost, the system may use the cost model to determine a conjecture model to predict a reaction for the human user based on an action of the device. The features for generating cost models and the conjecture models will be described in greater detail herein.

As described above, the present system may include methods for (1) data-driven estimation and/or learning of conjectures and associated depth; and (2) data-driven design of algorithmic mechanisms for exploring the conjectural equilibrium space by influencing the strategic agent(s) behaviors through adaptively adjusting and estimating deployed strategies. In additional examples, the system may generate models for the first agent to (1) classify a second agent as strategic or non-strategic; (2) iteratively declare different strategies and compute a data-driven conjecture for each strategic agent's response to the declared strategy; and (3) use the collection of declared strategies and data-driven conjectures to determine and declare a strategy that minimizes the cost of the first agent through the predicted influence on responses of the second agent.

In various examples, the system may generate and estimate best-response type conjectures that capture how opponents may reason about one another in strategic environments. In some examples, the “best-response” may be defined by domain design and may be based on a predetermined objective for a specific area domain.

In particular, the system may enable the creation of processes for reasoning at different levels or depths when a first agent and a second agent are competing or interacting in the same environment. The system may include predetermined objectives or task specifications for the area domain that evaluates the actions or reactions of the agents and determine the impact on an environment state. In additional examples, for different depths or levels of the iterated best-response type reasoning, the system may define an equilibrium concept that is interpretable and can be estimated by data-driven methods. For instance, the system may collect observed data for an autonomous-vehicle domain, where the first agent is an autonomous vehicle and the second agents are other vehicles. The system may collect data based on observing the other vehicles in the environment and determine the best action for the first agent based on the observations. The system also provides methods for assessing the stability and consistency of conjectures.

In a non-limiting example, the system may be configured to operate in a patient mobility rehabilitation domain, where the first agent is a rehabilitation exoskeleton and the second agent is a patient operating the rehabilitation exoskeleton. The rehabilitation exoskeleton may be configured by domain design to provide an initial amount of support for the patient and gradually decrease the amount of support over a time period. The amount of support may be device dependent and may include a level of torque for a specific joint. A domain designer may define initial parameters, including treatment policies and objective parameters for the system to meet. The rehabilitation exoskeleton may provide feedback with patient metrics based on adjustments to a device function, such as decreased support. The system may determine to continue to increase, decrease, or maintain the current amount of support based on the patient metrics, treatment time, and treatment policies. The data for the rehabilitation exoskeleton may be stored together as training data for generating machine learning models for the specific device.

In some examples, the system may include methods and procedures for data-driven learning of conjectural variations. The system may include the variations or derivatives of mappings associated with conjectures indicating how the second agent reacts to an observed action of a third agent. For instance, the system may observe how a first user-driven vehicle reacts based on the actions of a second user-driven vehicle. Moreover, the system may leverage the learning procedures to provide a method for exploring the space of interpretable equilibria and determining which announced conjectures or actions (“predicted reaction”) corresponding to a first conjecture lead to equilibria that are of the minimum cost to the announcer (one of the players, e.g., a machine in a human-machine interaction scenario), are social-cost minimizing (sum of all players costs), or are completely competitive in nature (e.g., Nash equilibrium). By using data-driven learning, the present system is able to generate cost models and conjecture models based on observations of the actions of an opponent without knowing the cost and/or other hidden data.

In some examples, the system may determine estimated conjectures by having a first agent explore and observe an action space (“world environment”) to generate a cost model and conjecture model. Then, the system may update the estimated conjectures continuously over time. For simplicity and based on observations, the present system may determine estimates in a quadratic setting and determine conjectural variations using linear maps. The system uses quadratic approximations that are able to capture local behaviors in non-convex settings. Additionally, the system may mathematically characterize the gap between the quadratic approximation and the non-convex problem. This enables the present system to apply a method in more general settings than quadratic or convex ones.

The system provides a method for data-driven synthesis of adaptive mechanisms of influence. In particular, the system provides a procedure based on the methods, as will be described herein. One agent or a third-party entity can use that to drive the agents to one of the different equilibrium concepts.

As described here, the system provides a data-driven method for updating agent and world models based on new observation data received. Furthermore, the system may also learn by analyzing learning dynamics and synthesizing learning algorithms for human-machine interaction in a plurality of domain areas. In some examples, the system may observe user action based on sensory input and train updated models with the observed user action to improve models over time. The system includes different methods and parameters for the models to synthesize and/or map after collecting new data to help the system further optimize the data processing for training data. For example, the system may synthesize actions based on variable time stepping (e.g., fast, medium, slow). In an additional example, the system may plot the actions of the machine relative to the reactions of humans by using more than one convergence function (e.g., Nash equilibria and Stackelberg equilibria). Accordingly, the system may continuously improve based on varying methods to gather more training data and improve domain models.

By integrating observed data for generated updated models, the system is not only able to continuously gather training data but can also learn from the training data by continuously optimizing conjecture models. For instance, based on the observed data and/or related comparing predicted actions to actual actions, the system provides a data-driven method to continuously learn and optimize conjectural models based on observed differences. As such, as the system learns, the optimizer component, the estimator component, the conjecture component, the strategy component, the agent and world models, and other components may execute more efficiently and accurately.

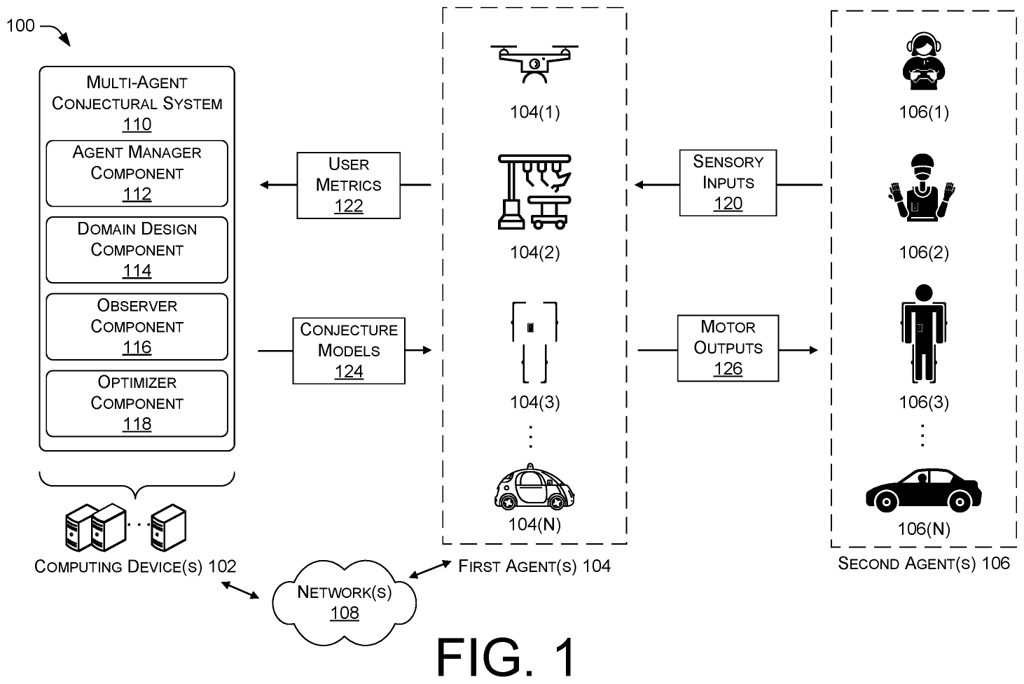

FIG. 1 illustrates an example system 100, including a multi-agent conjectural system configured to optimize interactions between example device first agents and example operator second agents. The system 100 may include first agent(s) 104 that interacts with second agent(s) 106, through one or more network(s) 108, to interact with the computing device(s) 102. In some examples, the network(s) 108 may be any type of network known in the art, such as the Internet. Moreover, the computing device(s) 102 and/or the first agent(s) 104 may be communicatively coupled to the network(s) 108 in any manner, such as by a wired or wireless connection.

The computing device(s) 102 may include any components that may be used to facilitate interaction between the computing device(s) 102 and the first agent(s) 104. For example, the computing device(s) 102 may configure a multi-agent conjectural system 110, including an agent manager component 112, a domain design component 114, an observer component 116, and an optimizer component 118.

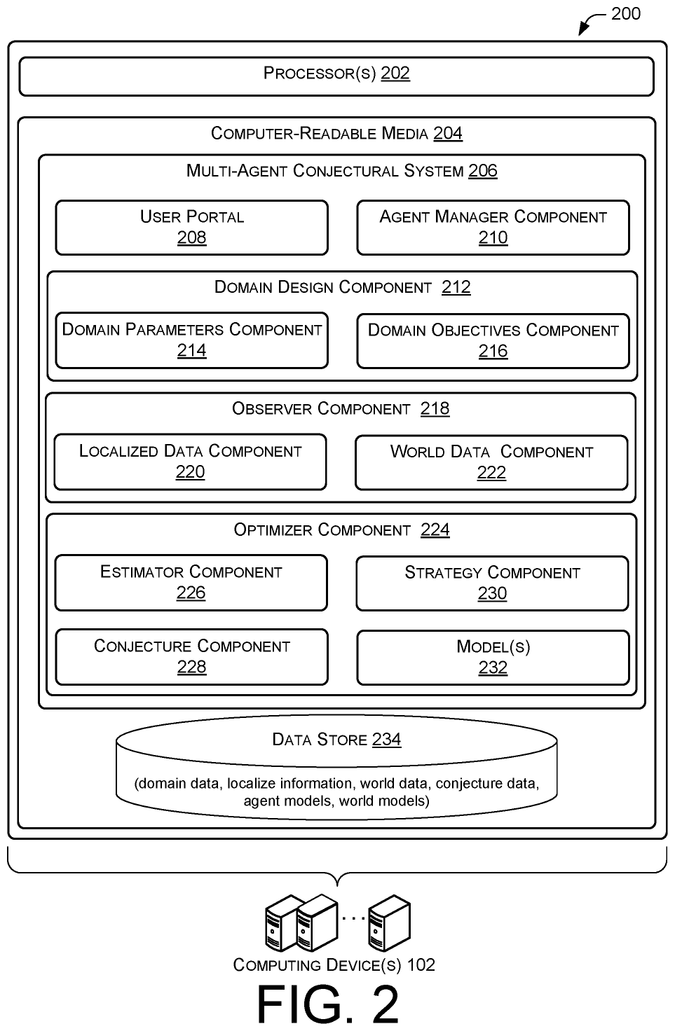

The multi-agent conjectural system 110 may receive and manage data associated with the first agent(s) 104 and/or the second agent(s) 106 via the agent manager component 112. In some instances, the multi-agent conjectural system 110 can correspond to a multi-agent conjectural system 206 of FIG. 2, where features may be described in greater detail. In some examples, the agent manager component 112 may receive data associated with actions of the second agent(s) 106 through observations and/or sensory inputs from the first agent(s) 104.

The agent manager component 112 may generate one or more data structures to store information associated with agents. The information associated with the agents may include observations of the environment and/or state. In some instances, the agent manager component 112 can correspond to the agent manager component 210 of FIG. 2, where features may be described in greater detail.

The agent manager component 112 may maintain one or more models for the agents. As described, the present system may determine a conjecture model for a human user (e.g., second agent 106) based on mapping the actions of the device (e.g., first agent 104) to the actions of the human user. The agent manager component 112 may maintain data associated with the “game” between n agents and is defined by:
the set of players indexed by [symbol] ={1, . . . , n},
the action space of each player, namely Xᵢ for each i∈ [symbol] ; the system denotes the joint action space by X=X₁× . . . ×Xₙ, and
the cost function of each player, namely ƒᵢ:X→ [symbol] .
   An agent may seek to minimize its cost ƒᵢ with respect to its choice variable xᵢ. The cost function of agent i may depend on other agents' actions xⱼ∈ [symbol] \{i}. The agent manager component 112 may use the notation x₋ᵢ=(x₁, . . . , x₋₁, xᵢ₊₁, . . . , xₙ) for all the actions excluding xᵢ. In some examples, the agent manager component 112 may manage data for dynamic games, including the environment in which the agents are interacting. The environment may include changes over time and may include definitions of states on which individual players' cost depends.

The agent manager component 112 may maintain the observed actions associated with the agents. Conjectures can be mappings from action spaces to action spaces or cost functions to action spaces. In some examples, the agent manager component 112 may define conjectures that include mappings from a first action space of a first agent 104 to the second action space of a second agent 106. The conjectures based on mapping action space to action space enable the data-driven continual learning process.

In some examples, the agent manager component 112 and the domain design component 114 may determine objectives for the interactions between the first agent(s) 104 and the second agent(s) 106.

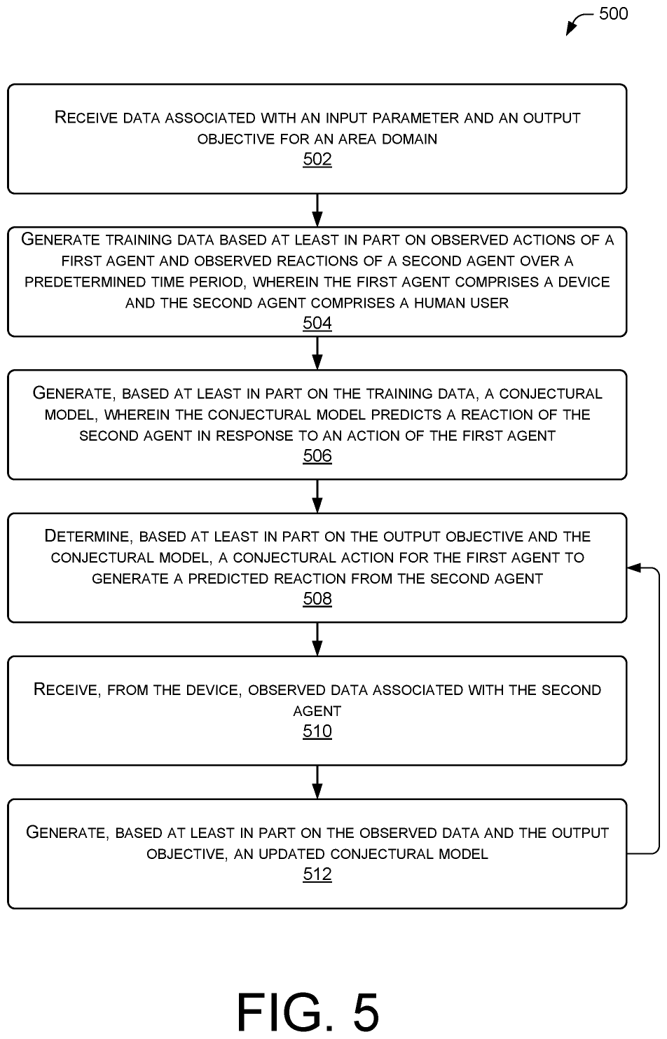

The domain design component 114 and the agent manager component 112 may generate one or more cost functions for agents within a predefined “environment” and optimize decision-making for a first agent. The process to optimize decision-making will be described herein in more detail with respect to FIGS. 5-11. In some examples, the agent manager component 112 may present a user interface for user input to provide sensory input associated with the domain.

The domain design component 114 may be configured to receive a domain-specific configuration, including input parameters and output objectives. In some instances, the domain design component 114 can correspond to the domain design component 212 of FIG. 2, where features may be described in greater detail. The domain design component 114 may include one or more domain models to process metrics specific to a device. For instance, a device monitoring user health may include an energy consumption model and/or dynamic metabolic functions. In various examples, the domain design component 114 may determine the domain model of the input data while processing the input.

In some examples, the domain design component 114 and the agent manager component 112 may process sensory input and generate an updated model to control a device by adjusting control parameters and/or adjusting motor outputs. In various examples, the domain design component 114, the observer component 116, and the agent manager component 112 may use the domain design with output objectives to determine an estimated “best-response” type conjecture. The multi-agent conjectural system 110 may provide the device control parameters to control device actions, via a conjecture model, to cause and/or anticipate a reaction from the second agent(s) 106.

In various examples, the domain design component 114 may include designs for different area domains. For any area domain, the domain design component 114 may include data associated with the design including, but not limited to, a first agent, a second agent, any data including input, output, initial parameters and/or constants, parameters to measure during the game, conjecture variables, performance threshold, depth level tolerance, and the like. The domain design component 114 may receive the data in real-time or near real-time. The domain design component 114 may use the data received from the system or external to the system to train one or more models. The inputs and outputs may be expressed from the perspective of one of the agents. The input may include a vector of influence that the agent has over the system. The agent may use the input to achieve a goal, a performance criterion, and/or domain objective, which may include a task performance metric or a goal-directed task. The output may include a measurable quality of the overall task. In various examples, the agents can optimize the performance of the output or use the output to derive an intrinsic drive to play the game, or use the output to achieve multiple performance criteria. The agents may be situated in a fixed environment with a set of rules that can be instantiated or measured. The domain design component 114 may use one or more data structures, including arrays and pointers, to receive data for the different time intervals or parameter changes. The system may compare data, including conjecture variables, and determine that the conjecture variables fail to satisfy a performance threshold and/or a depth level tolerance.

In a first non-limiting example of an area domain, the area domain may be associated with an artificial intelligence (AI) assistant. The device associated with the first agent may comprise a trainer component. The human user associated with the second agent may be an operator of the device. The input parameter may comprise at least one of a simulated training experience or opponent strategies, and the output objective comprises at least one of a training performance or long-term learning of the operator.

In a second non-limiting example of an area domain, the area domain may be associated with a brain-computer interface (BCI). The device associated with the first agent may comprise one or more sensors to measure neural activity. The human user associated with the second agent may be an operator of the device. The input parameter comprises at least one of neural activity data and calibration parameters, and the output objective comprises at least one of task performance and target performance.

In a third non-limiting example of an area domain, the area domain may be associated with a human-computer interface (HCI). The device associated with the first agent may comprise one or more sensors. The human user associated with the second agent may be an operator of the device. The input parameter comprises at least one biometric input, a kinesthetic input, or controller characteristics, and the output objective comprises at least one of an intent-driven performance or a decrease in human workload based at least in part on decreasing an amount of user interaction.

In a fourth non-limiting example of an area domain, the area domain may be associated with interactive entertainment. The device associated with the first agent may comprise an adaptive AI component and one or more controllers or input devices. The human user associated with the second agent may be a gamer. The input parameter comprises at least one of a controller input or non-player character actions, and the output objective comprises at least one of a player objective or a game objective.

In a fifth non-limiting example of an area domain, the area domain may be associated with physical rehabilitation. The device associated with the first agent may comprise a rehabilitation exoskeleton and one or more sensors comprising one or more of a respirometer, a pedometer, a heart-rate monitor, or at least one joint torque monitor. The human user associated with the second agent may be a patient. The input data comprises treatment results data and a treatment policy, and the output objective comprises at least one of decreasing user pain and training user behavior. In some examples, the domain design component 114 adjusting the one or more control parameters comprises changing an amount of assistance provided by the exoskeleton device based at least in part on an output objective. The domain design component 114 may include constant data associated with the human user comprising one or more of age, height, weight, sex, cadence, or a metabolic constant. In some examples, the domain design component 114 may receive data from one or more sensors and determine the observed data comprises an energy consumption based on a predetermined metabolic function. In various examples, the domain design component 114 may receive data from the one or more sensors indicating an amount of assistance provided by the exoskeleton device.

In a sixth non-limiting example of an area domain, the area domain may be associated with autonomous vehicles. The device associated with the first agent may comprise an autonomous vehicle. The human user associated with the second agent may be a driver in a non-autonomous vehicle. The input parameter comprises at least one of acceleration or steering or a vehicle state, and the output objective comprises at least one of fuel usage or trip duration.

In another non-limiting example of an area domain, the area domain may be associated with computer security. The device associated with the first agent may comprise a defender. The human user associated with the second agent may be an attacker. The input parameter comprises at least one security policy or infrastructure access, and the output objective comprises at least one of finding exploits or preventing a data breach.

The observer component 116 may include localized data and world data to estimate interactions. In some instances, the observer component 116 can correspond to the observer component 218 of FIG. 2, where features may be described in greater detail. The observer component 116 may receive time-variant and static information related to the second agent(s) 106 and the state of the environment. In some examples, the observer component 116 may determine the data used for modeling. For instance, the observer component 116 may receive a stream of sensor data from the first agent(s) 104, and the observer component 116 and the domain design component 114 may filter the stream of sensor data to determine the data used to map action data to action data based on a specific parameter or time change.

The optimizer component 118 may determine best-response type conjectures for a first agent 104 interacting with a second agent 106. In some instances, the optimizer component 118 can correspond to the optimizer component 224 of FIG. 2, where features and formulas may be described in greater detail. The optimizer component 118 may use the notation r_{i→j}:Xᵢ→Xⱼ to denote player i's conjecture about player j, which is expressed as a mapping or correspondence from player i's action space Xᵢ to player j's action space Xⱼ. In various examples, a natural conjecture may define a “best response” as:

$${r}_{1 \to 2} ( {x}_{1} ) = arg {min}_{{x}_{2} ∈ {X}_{2}} {f}_{2} ( {x}_{1} , {x}_{2} )$$

Let r_{i→j}(Xᵢ)=xⱼ be the null conjecture. Thus, player i does not have any conjecture about how xⱼ varies in response to xᵢ or rather, the null conjecture is a constant function. A conjectural variation is a variation in a conjecture which captures first-order effects of how a first player believes an opponent reacts to its choice of action. Mathematically, this is the derivative of the conjecture. Accordingly, within the context of the current disclosure, a “conjecture” may also refer to a mathematical description of how players anticipate their opponent's behavior.

As described herein, the optimizer component 118 may apply methods for (1) data-driven estimation associated with the learning of conjectures and associated depth; and (2) data-driven design of algorithmic mechanisms for exploring the conjectural equilibrium space by influencing the strategic agent(s) behaviors through adaptively adjusting and estimating deployed strategies.

In a non-limiting example, the optimizer component 118 may determine the strategy associated with the first agent. The example agent i (e.g., first agent 104) may choose decision variable uᵢ and incur cost cᵢ(uᵢ, u₋ᵢ) that is a function of uᵢ and other variables u₋ᵢ seen by agent i. To minimize the cost incurred for agent i, the system may determine how decision variable uᵢ influences the other variables −i should form an estimate û₋ᵢⁱ(uᵢ) of the true influence, and this estimate should inform i's strategy uᵢ⁻ⁱ(u₋ᵢ).

When the other variables u₋ᵢ are themselves chosen by agents j∈I\{i}=−i in an effort to minimize their own costs {cⱼ}_{j∈-i}, the collection of n=#(I) agents participate in an n-player game, and the estimate {ûⱼⁱ}_{j∈-i} are i's conjectures about the other agents j∈−i. If the agent i's conjectures are consistent in that they accurately predict the responses of the other agents −i, then agent i can exploit this knowledge to improve their outcome at the expense of the outcomes of others. Specifically, agent i will: (1) classify the other agents as strategic or non-strategic; (2) iteratively declare different strategies and compute a data-driven conjecture for each strategic agent's response to the declared strategy; and (3) use the collection of declared strategies and data-driven conjectures to determine and declare a strategy that minimizes i's cost through their predicted influence on other agent responses.

The optimizer component 118 may output models (e.g., conjecture models 124), including one or more cost models and/or conjecture models.

The second agent(s) 106, via the first agent(s) 104, may interact with the computing device(s) 102. The second agent(s) 106 may include any entity, individuals, patients, health care providers, writers, analysts, students, professors, and the like. In various examples, the second agent(s) 106 may include formal collaborators and/or medical providers who conduct diagnoses on behalf of a patient and/or a customer. The second agent(s) 106 may be prompted by the system to generate training data, including transmitting device data. This user feedback and other user interactions may be used by the multi-agent conjectural system 110 to continuously learn and improve generated models. In additional examples, the second agent(s) 106 may be part of an organized crowdsourcing network, such as the Mechanical Turk™ crowdsourcing platform.

The second agent(s) 106 may include any individual human user or entities operating devices associated with the corresponding first agent(s) 104 to perform various functions associated with the first agent(s) 104, which may include at least some of the operations and/or components discussed above with respect to the computing device(s) 102. The users may operate the first agent(s) 104 using any input/output devices, including but not limited to mouse, monitors, displays, augmented glasses, keyboard, cameras, microphones, speakers, and headsets. In various examples, the computing device(s) 102 and/or the first agent(s) 104 may include a text-to-speech component that may allow the first agent(s) 104 to conduct a dialog session with the second agent(s) 106 by verbal dialog.

The first agent(s) 104 may receive domain content from the computing device(s) 102, including user interfaces to interact with the second agent(s) 106. In some examples, the second agent(s) 106 may include any number of human collaborators who are engaged by the first agent(s) 104 to interact with the computing device(s) 102 and verify the functions of one or more components of the computing device(s) 102. In some examples, in response to an action performed by the first agent(s) 104, the multi-agent conjectural system 110 and associated components may automatically observe a reaction of the second agent(s) 106, and the system may determine whether the observed reactions match a conjecture. The differences between observed and conjecture reactions may be stored to help train the system. The first agent(s) 104 may include one or more sensors to receive sensory input. The sensors may include but is not limited to, cameras, radars, global positioning satellite (GPS), lidars, electroencephalography (EEG), magnetoencephalography (MEG), electrooculography (EOG), magnetic resonance imaging (MRI), microelectrode arrays (MEAs), electrocorticography (ECoG), respirometer, pedometer, heart-rate monitor, barometer, altimeter, oximeter, and the like.

In a non-limiting example, the multi-agent conjectural system 110 may generate the decision-making algorithms for the first agent(s) 104 to interact with the second agent(s) 106. In some instances, the first agent(s) 104 may receive example sensory inputs 120 from the second agent(s) 106. The first agent(s) 104 may transmit example user metrics 122 to the computing device(s) 102. The multi-agent conjectural system 110 may generate example conjecture models 124, and the first agent(s) 104 may use the conjecture models 124 to determine example motor outputs 126. The example motor outputs 126 may include an action for the device of the first agent(s) 104 to perform to cause a reaction from the user of the second agent(s) 106.

In some instances, the first agent(s) 104 may be an example device, including an example camera drone 104(1), an example robotic arm 104(2), an example exoskeleton 104(3), and an example autonomous vehicle 104(N). In some instances, the second agent(s) 106 may be example human users operating or interacting with the first agent(s) 104 and include an example drone operator 106(1), an example robotic arm operator 106(2), an example exoskeleton user 106(3), and an example user-driven vehicle 106(N).

In a first domain example, the example camera drone 104(1) may interact with the example drone operator 106(1). The example camera drone 104(1) may receive the example sensory inputs 120, including flight control input from the drone operator 106(1). The example camera drone 104(1) may transmit the flight control input as the example user metrics 122. The system may determine a flight control model as the example conjecture models 124 to guide the example camera drone 104(1) to provide a smoother flight path and/or redirect the camera to a selected point of focus based on the flight control input. The example motor outputs 126 may include an action for the example camera drone 104(1) to perform in anticipation of input from the example drone operator 106(1).

In a second domain example, the example robotic arm 104(2) may interact with the example robotic arm operator 106(2). The example robotic arm 104(2) may receive the example sensory inputs 120, including movement directions, from the example robotic arm operator 106(2). The example robotic arm 104(2) may transmit the user input as the example user metrics 122. The system may determine an arm movement model as the example conjecture models 124 to guide the example robotic arm 104(2) to provide smoother operating motion and/or direct the arm to a specified point in anticipation of user input. For example, if the example robotic arm 104(2) includes an injection needle, the system may help steady the needle after identifying the point of injection. The example motor outputs 126 may include a steadying action for the example robotic arm 104(2) to perform in anticipation of input from the example robotic arm operator 106(2).

In a third domain example, the example exoskeleton 104(3) may interact with the example exoskeleton user 106(3). The example exoskeleton 104(3) may receive the example sensory inputs 120, including captured movement, from the example exoskeleton user 106(3). The example exoskeleton 104(3) may transmit the user input and sensory input as the example user metrics 122. As described above, the system may be configured to operate in a patient mobility rehabilitation domain, where the first agent is a rehabilitation exoskeleton (e.g., example exoskeleton 104(3)) and the second agent is patient (e.g., exoskeleton user 106(3)) operating the rehabilitation exoskeleton. The rehabilitation exoskeleton may be configured by domain design to provide an initial amount of support for the exoskeleton user 106(3) and gradually decrease the amount of support over a time period. The amount of support may be device dependent and may include a level of torque for a specific joint. A domain designer may define initial parameters, including treatment policies and objective parameters for the system to meet. The rehabilitation exoskeleton may provide feedback with patient metrics based on adjustments to a device function, such as decreased support, and the system may determine whether to continue to increase, decrease, or maintain the current amount of support based on the patient metrics, treatment time, and treatment policies. The data for the rehabilitation exoskeleton may be stored together as training data for generating machine learning models for the specific device associated with the example exoskeleton 104(3).

In a fourth domain example, the example autonomous vehicle 104(N) may interact with the example user-driven vehicle 106(N). The system may collect observed data for the autonomous-vehicle domain, wherein the first agent is the example autonomous vehicle 104(N) and the second agent is the example user-driven vehicle 106(N). The system may collect data based on observing other vehicles and the example user-driven vehicle 106(N) in the environment and may determine the best action for the example autonomous vehicle 104(N) based on the observations. The example autonomous vehicle 104(N) may include sensors including cameras, radars, global positioning satellite (GPS), and lidars to receive the example sensory inputs 120, including movement and reactions, from the example user-driven vehicle 106(N). The example autonomous vehicle 104(N) may transmit the observed vehicle movement and reactions as the example user metrics 122. The system may determine a control function as the example conjecture models 124 to guide the example autonomous vehicle 104(N) to steer safely in anticipation of movement from the example user-driven vehicle 106(N). The example motor outputs 126 may include a control function for the example autonomous vehicle 104(N) to perform in anticipation of input from the example user-driven vehicle 106(N).

The system may continuously process the example sensory inputs 120 from the second agent(s) 106 and process the user metrics 122. The optimizer component 118 may continuously update the conjecture models 124, and the first agent(s) 104 may use the conjecture models 124 to determine example motor outputs 126. The agent manager component 112 may continuously observe the actions of the agents in the system to help the first agent determine an optimal action to take to predict and cause the second agent to perform a predicted reaction. Based on objectives defined by the domain design component 114, the predicted reaction, and the observed reaction from the second agent(s) 106, the system may update one or more models (e.g., cost model, conjecture model, etc.) to improve the agent manager component 112, the domain design component 114, the observer component 116, and the optimizer component 118, the multi-agent conjectural system 110, and/or other associated components.

FIG. 2 is a block diagram of an illustrative computing architecture 200 of the computing device(s) 102 shown in FIG. 1. The computing architecture 200 may be implemented in a distributed or non-distributed computing environment.

The computing architecture 200 may include one or more processors 202 and one or more computer-readable media 204 that stores various modules, data structures, applications, programs, or other data. The computer-readable media 204 may include instructions that, when executed by the one or more processors 202, cause the processors to perform the operations described herein for the system 100.

The computer-readable media 204 may include non-transitory computer-readable storage media, which may include hard drives, floppy diskettes, optical disks, CD-ROMs, DVDs, read-only memories (ROMs), random access memories (RAMs), EPROMs, EEPROMs, flash memory, magnetic or optical cards, solid-state memory devices, or other types of storage media appropriate for storing electronic instructions. In addition, in some embodiments, the computer-readable media 204 may include a transitory computer-readable signal (in compressed or uncompressed form). Examples of computer-readable signals, whether modulated using a carrier or not, include, but are not limited to, signals that a computer system hosting or running a computer program may be configured to access, including signals downloaded through the Internet or other networks. The order in which the operations are described is not intended to be construed as a limitation, and any number of the described operations may be combined in any order and/or in parallel to implement the process. Furthermore, the operations described below may be implemented on a single device or multiple devices.

In some embodiments, the computer-readable media 204 may store a multi-agent conjectural system 206 and associated components, and the data store 234. The multi-agent conjectural system 206 may include a user portal 208, an agent manager component 210, a domain design component 212 and associated components, an observer component 218 and associated components, and an optimizer component 224 and associated components, which are described in turn. The components may be stored together or in a distributed arrangement.

The user portal 208 may generate a graphical user interface to interact with a human user. In some examples, the human user may include the second agent(s) 106 or a domain expert to design a domain area. The user portal 208 may generate a graphical user interface to provide guidance and prompts to collaborate with the second agent(s) 106 to register a user account for storing information associated with game sessions, training sessions, and/or related functions. In some examples, the graphical user interface may include prompts to request user input to register a device and associate it with the user account.

In various examples, the user portal 208 may present interface elements to prompt user input to formulate games and/or explore training sessions. The user portal 208 may include prompts for user input for device configuration details and to initiate a device. The user portal 208 may include prompts to explore training data to upload to the device.

In some examples, the user portal 208 may allow a user to create a user account associated with user data to store individual session data as session models and/or as models. The user portal 208 may allow the second agent 106 to define and persist a personalized set-up, model, or configuration for any device or domain area (e.g., a model of device configuration in a home entertainment system and/or a model of personal medical information). The user portal 208 may allow a user or an entity, including the second agent(s) 106 to create, save, browse, open, and edit the user data and/or update the user data in response to changes in configuration. For instance, the user portal 208 may receive input to register a user account for the second agent(s) 106 and may receive health metrics of the second agent(s) 106. The health metrics may include user-specific information, including but not limited to height, weight, sex, age, cadence, metabolic constant, VO2 max, and the like. Within the context of the current disclosure, the term “metabolic constant” and its equivalents may refer to a basal metabolic rate (BMR). The term “VO2 max” and its equivalents may refer to a maximum rate of oxygen consumption measured during incremental exercise.

In various examples, the system may allow a user account to be associated with multiple devices and/or multiple models. For instance, a patient at a physical rehabilitation clinic may be registered to use one or more rehabilitation devices.

In some examples, the user portal 208 may configure the user interface to receive domain design from a domain designer. The domain design may allow an expert to design a domain area and specify a vector of influence for input and/or an objective for output. In various examples, the domain design may allow a domain expert to specify control parameters for initiating a device associated with the first agent(s) 104.

In some examples, the user portal 208 may receive user input for specifying a domain configuration and send the domain configuration to the agent manager component 210 to generate data structures for storing information associated with agents. The user portal 208 may also send domain configuration to the domain design component 212.

The agent manager component 210 may generate one or more data structures to store information associated with agents. In some instances, the agent manager component 210 can correspond to the agent manager component 112 of FIG. 1. As described herein with respect to the agent manager component 112, the agent manager component 210 may generate data structures to manage data associated with agents, observed actions, and/or associated world data. The data associated with the agents may include observations of the environment and/or state.

The agent manager component 210 may maintain one or more models for the agents. As described, the present system may determine a conjecture model for a human user (e.g., second agent 106) based on mapping the actions of the device (e.g., first agent 104) to the actions of the human user. The agent manager component 210 may maintain data associated with the “game” between n agents and is defined by:
the set of players indexed by [symbol] ={1, . . . , n},
the action or strategy (the “action or strategy” may be referred to herein as the “action”) space of each player, namely Xᵢ for each i∈ [symbol] ; the system denotes the joint action space by X=X₁× . . . ×Xₙ, and
the cost function of each player, namely ƒᵢ:X→ [symbol] .

In some examples, the agent manager component 210 may determine that an individual agent may seek to minimize its cost ƒᵢ with respect to its choice variable xᵢ. The cost function of agent i may depend on other agents' actions xⱼ∈ [symbol] \{i}. The agent manager component 210 may use the notation x₋ᵢ=(x₁, . . . , xᵢ₋₁, xᵢ₊₁, . . . , xₙ) for all the actions excluding xᵢ. In various examples, the agent manager component 210 may manage data for dynamic games, including the environment in which the agents are interacting. The environment may include changes over time and may include definitions of states on which individual players' cost depends.

The agent manager component 210 may maintain the observed actions associated with the agents. Conjectures can be mappings from action spaces to action spaces or cost functions to action spaces. In some examples, the agent manager component 210 may define conjectures that include mappings from a first action space of a first agent 104 to a second action space of a second agent 106. The conjectures based on mapping action space to action space enable the data-driven continual learning process. The notation r_{i→j}:Xᵢ→Xⱼ denotes player i's conjecture about player j, which is expressed as a mapping or correspondence from player i's action space Xᵢ to player j's action space Xⱼ. For example, the conjecture may include a “best response”:

$${r}_{1 \to 2} ( {x}_{1} ) = arg {min}_{{x}_{2} ∈ {X}_{2}} {f}_{2} ( {x}_{1} , {x}_{2} )$$

Let r_{i→j}(xᵢ)=xⱼ be the null conjecture. That is, player i does not have any conjecture about how xⱼ varies in response to xᵢ or rather, the null conjecture is a constant function.

In some examples, the agent manager component 210 and the domain design component 212 may determine objectives for the interactions between the first agent(s) 104 and the second agent(s) 106. The agent manager component 210 and the domain design component 212 may define at least one area domain and associated parameters of an area domain for the first agent(s) 104.

The domain design component 212 may include a domain parameters component 214 and a domain objectives component 216. In some instances, the domain design component 212 can correspond to the domain design component 114 of FIG. 1. As described herein with respect to domain design component 114, the domain design component 212 may include designs for different area domains. For any area domain, the domain design component 212 and associated components may manage data associated with any domain design. The domain design component 212 may receive the data in real-time or near real-time. The domain design component 212 may use data received from the system and/or external to the system to train one or more models. The inputs and outputs may be expressed from the perspective of one of the agents. The input may include a vector of influence that the agent has over the system. The agent may use the input to achieve a goal, a performance criterion, and/or domain objective, which may include a task performance metric or a goal-directed task. The output may include a measurable quality of the overall task. In various examples, the agents can optimize the performance of the output or use the output to derive an intrinsic drive to play the game, or use the output to achieve multiple performance criteria. The agents may be situated in a fixed environment with a set of rules that can be instantiated or measured. The domain design component 212 and associated components may use one or more data structures, including arrays and pointers, to receive data for the different time intervals or parameter changes. The system may compare data, including conjecture variables, and determine that the conjecture variables satisfy or fail to satisfy a performance threshold and/or a depth level tolerance.

The domain design component 212 may be configured to analyze data associated with different knowledge domains and/or area domains. In a non-limiting example, the knowledge domains may include a specific subject area, topic, industry, discipline, and/or field in which a current application is intended to apply. In a non-limiting example, the area domain may include a brain-computer interface, computer science, engineering, biology, chemistry, medical, business, finance, and the like. In some examples, the domain design component 212 may use the domain parameters component 214 to process to data received from the first agent 104 to determine which action or strategy to perform in order to cause a predicted responding action or strategy from the second agent 106. The domain design component 212 may align conjecture models based on the domain objectives component 216. To align a conjecture model to a domain objective, the domain design component 212 may determine an objective output and determine the best input using the conjecture model to cause the objective output.

The domain design component 212 may include one or more domain models to process metrics specific to a device. For instance, a device monitoring user health may include an energy consumption model and/or dynamic metabolic functions. In various examples, the domain design component 212 may determine the domain model of the input data while processing the input. In some examples, the domain design component 212 and the agent manager component 210 may process sensory input and generate an updated model to control a device by adjusting control parameters and/or adjusting motor outputs. In various examples, the domain design component 212, the observer component 218, and the agent manager component 210 may use the domain design with output objectives to determine an estimated “best-response” type conjecture. The multi-agent conjectural system 206 may provide the device control parameters to control device actions via a conjecture model to cause and/or anticipate a reaction from the second agent(s) 106.

The domain parameters component 214 may manage data associated with the parameters for a domain. The domain parameters component 214 may manage data associated with parameters specified in a domain design. The data and/parameters may including, but is not limited to, a first agent, a second agent, any data including input, output, initial parameters and/or constants, parameters to measure during the game, conjecture variables, performance threshold, depth level tolerance, and the like. The domain parameters component 214 may store and transmit data associated with any input parameter for an area domain. The domain parameters component 214 may send data associated with the domain design to initiate a device (e.g., first agent) including input parameter. In an example rehabilitation domain, domain parameters component 214 may send or receive constant data associated with a human user and input data associated with adjusting one or more control parameters of an exoskeleton device operated by the human user. The domain parameters component 214 may receive data associated with parameters as measured or observed by the device.

The domain objectives component 216 may manage data associated with the objectives for a domain. The domain objectives component 216 may store and transmit data associated with any output objective for an area domain. The domain objectives component 216 may send data associated with the domain design to initiate a device (e.g., first agent) including output objective and/or formulas to determine a desired output objective (e.g., dynamic metabolic function for a health system). The domain objectives component 216 may receive data associated with objectives as measured or observed by the device.

The agent may use the input to achieve a goal, a performance criterion, and/or domain objective, which may include a task performance metric or a goal-directed task. The output may include a measurable quality of the overall task. In various examples, the agents can optimize the performance of the output or use the output to derive an intrinsic drive to play the game, or use the output to achieve multiple performance criteria. The agents may be situated in a fixed environment with a set of rules that can be instantiated or measured

The observer component 218 may include a localized data component 220 and a world data component 222. In some instances, the observer component 218 can correspond to the observer component 116 of FIG. 1. As described herein with respect to the observer component 116, the observer component 218 may receive time-variant and static information related to the second agent(s) 106 and the state of the environment including the localized data component 220 and the world data component 222. The observer component 218 may observe world events and generate training data for training cost models and conjectural models. In some examples, the observer component 218 may determine the data used for modeling. For instance, the observer component 218 may receive a stream of sensor data from the first agent(s) 104, and the observer component 218 and the domain design component 212 may filter the stream of sensor data to determine the data used to map action data to action data based on a specific parameter or time period. The observer component 218 may map the actions of a first agent relative to actions (or reactions) of a second agent to generate a joint action profile. The observer component 218 and the domain design component 212 may determine any difference between an observed action and a predicted reaction of the second agent 106 as determined by a conjectural model.

The optimizer component 224 may include an estimator component 226, a conjecture component 228, a strategy component 230, and model(s) 232. In some instances, the optimizer component 224 can correspond to the optimizer component 118 of FIG. 1. As described herein with respect to the optimizer component 118, the optimizer component 224 may determine a best-response type conjecture for the first agent 104 interacting with the second agent 106. The optimizer component 224 may configure the estimator component 226 to receive data and estimate a cost model for actions taken by the opponent. The optimizer component 224 may configure the conjecture component 228 to receive data and determine a conjecture model for the opponent. The optimizer component 224 may configure the strategy component 230 to receive observed data including difference between a conjecture and actual response of the opponent and determine to update one or more models.

In various examples, the optimizer component 224 may determine that the machine first agent can directly optimize over parameters of the response mapping to affect the human's conjecture about the machine and the response of the human. In the present example, the optimizer component 224 may use apply a reverse Stackelberg gradient to show that the equilibrium is the machine's minimum, which may indicate a high probability for one player to influence the other player.

The optimizer component 224 and associated components may determine a composable best-response type conjectures and corresponding interpretable equilibria. The optimizer component 224 may formulate a class of conjectures based on iterated best responses that are composable with one another. This formula leads to a characterization of a depth of reasoning. For example, the optimizer component 224 may determine that a first agent conjectures that a second agent is playing the best response to its action x₁. This may define the first level k=1 of best-response conjecture as:

$${r}_{1 \to 2}^{( 1 )} ( {x}_{1} ) = arg {min}_{{x}_{2} ∈ {X}_{2}} {f}_{2} ( {x}_{1} , {x}_{2} ) .$$

With this conjecture, the first agent may seek to optimize

$${min}_{{x}_{1} ∈ {X}_{1}} \{ {f}_{1} ( {x}_{1} , {x}_{2} ) \vert {x}_{2} = {r}_{1 \to 2}^{( 1 )} ( {x}_{1} ) \}$$

If the second agent has the null conjecture, which defines the notation as r_{2→1}⁽⁰⁾(x₂)=x₁, then the game between the two agents is characterized by two individual optimization problems:

$${min}_{{x}_{1} ∈ {X}_{1}} \{ {f}_{1} ( {x}_{1} , {x}_{2} ) \vert {x}_{2} = {r}_{1 \to 2}^{( 1 )} ( {x}_{1} ) \} \\ {min}_{{x}_{2} ∈ {X}_{2}} {f}_{1} ( {x}_{1} , {x}_{2} )$$

In another example, if the second agent also has a k=1 level conjecture, then the second problem is replaced by

$${min}_{{x}_{2} ∈ {X}_{2}} \{ {f}_{2} ( {x}_{1} , {x}_{2} ) \vert {x}_{1} = {r}_{2 \to 1}^{( 1 )} ( {x}_{2} ) \}$$

To solve these problems, the optimizer component 224 may apply the learning algorithms for the agents. The optimizer component 224 may describe the composability component, including the k=2 level conjecture, as follows from above, the first agent conjecturing at depth k=2 about the second agent. Then,

$${r}_{1 \to 2}^{( 2 )} ( {x}_{1} ) = arg {min}_{{x}_{2}} \{ {f}_{2} ( {x}_{1}^{′} , {x}_{2} ) \vert {x}_{1}^{′} = arg {min}_{{x}_{1}^{″}} \{ {f}_{1} ( {x}_{1}^{″} , {x}_{2}^{′} ) \vert {x}_{2}^{′} = arg {min}_{{x}_{2}^{″}} {f}_{2} ( {x}_{2}^{″} , {x}_{1} ) \} \}$$

so the output of this process is a mapping from x₁ to the reaction r_{1→2}⁽²⁾(x₁)∈X₂. If the system defines the mapping

$${b}_{21} ( {x}_{2} ) = arg {min}_{{x}_{2}^{′}} \{ {f}_{2} ( {x}_{2}^{′} , {x}_{1} ) \vert {x}_{1} = arg {min}_{{x}_{1}^{′}} {f}_{2} ( {x}_{1}^{′} , {x}_{2} ) \}$$

$$then$$

$${r}_{1 \to 2}^{( 2 )} ( {x}_{1} ) = {b}_{12} ( {r}_{1 \to 2}^{( 1 )} ( {x}_{1} ) ) .$$

Additionally, the system may have

$$\begin{matrix}{r}_{1 \to 2}^{( 3 )} ( {x}_{1} ) = {b}_{21} ( {b}_{21} ( {r}_{1 \to 2}^{( 1 )} ( {x}_{1} ) ) \\ = arg {min}_{{x}_{2}} \{ {f}_{2} ( {x}_{1}^{′} , {x}_{2} ) \vert {x}_{1}^{′} = arg {min}_{{x}_{1}^{″}} \{ {f}_{1} ( {x}_{1}^{″} , {x}_{2}^{′} ) \vert\end{matrix} \\ {x}_{2}^{′} = arg {min}_{{x}_{2}^{″}} \{ {f}_{2} ( {x}_{1}^{″} , {x}_{2}^{″} ) \vert {x}_{1}^{″} = arg {min}_{{x}_{1}^{′′′}} \{ {f}_{1} ( {x}_{1}^{′′′} , {x}_{2}^{″} ) \vert {x}_{2}^{″} = arg {min}_{{x}_{2}^{″}} {f}_{2} ( {x}_{2}^{′′′} , {x}_{1} ) \} \}$$

Furthermore, the system may have

$${r}_{i \to j}^{( k )} ( {x}_{i} ) = {b}_{ji}^{( k - 1 )} ( {r}_{i \to j}^{( 1 )} ( {x}_{i} ) )$$

$$Wherein$$

$${b}_{j i}^{( k - 1 )} ≡ {\underbrace{{b}_{ji} ∘ … ∘ {b}_{ji}}}_{( k - 1 ) times composition}$$

with b₁₂ defined completely analogously to b₂₁.

Thus, an equilibrium to the game in which agents are boundedly rational and reasoning at a depth of k and [symbol] , respectively, is a solution to the set of optimization problems (which may be solved independently by the two agents) given below:

$${min}_{{x}_{1} ∈ {X}_{1}} \{ {f}_{1} ( {x}_{1} , {x}_{2} ) \vert {x}_{2} = {r}_{1 \to 2}^{( k )} ( {x}_{1} ) \} \\ {min}_{{x}_{2} ∈ {X}_{2}} \{ {f}_{2} ( {x}_{1} , {x}_{2} ) \vert {x}_{1} = {r}_{2 \to 1}^{( ℓ )} ( {x}_{2} ) \}$$

From a theoretical point of view, the system may define the following theorems:
Theorem 1. As (k, [symbol] )→(∞,∞), solutions to the problems in (1) and (2)—namely, (k, [symbol] ) best response conjectural variations equilibria-approach a consistent conjectural variations equilibrium. The notion of a consistent conjectural variations equilibrium simply means that each agent is playing an optimal solution to their individual problem given their conjecture and their conjectured solution for their opponent is consistent with the opponent's actual play.
Theorem 2. Best response conjectural variations equilibria of depth (k+1,k) are consistent for the agent reasoning at the (k+1)-th level.

In additional examples, the optimizer component 224 may use the notation r_{i→j}:Xᵢ→Xⱼ to denote player i's conjecture about player j, which is expressed as a mapping or correspondence from player i's action space Xᵢ to player j's action space Xⱼ. In various examples, a natural conjecture may define a “best response” as:

$${r}_{1 \to 2} ( {x}_{1} ) = arg {min}_{{x}_{2} ∈ {X}_{2}} {f}_{2} ( {x}_{1} , {x}_{2} )$$

Let r_{i→j}(xᵢ)=xⱼ be the null conjecture. Thus, player i does not have any conjecture about how xⱼ varies in response to xᵢ or rather, the null conjecture is a constant function. A conjectural variation is a variation in a conjecture which captures first-order effects of how a first player believes an opponent reacts to its choice of action. Mathematically, this is the derivative of the conjecture. Accordingly, within the context of the current disclosure, a “conjecture” may also refer to a mathematical description of how players anticipate their opponent's behavior.

As described herein, the optimizer component 224 may include methods for (1) data-driven estimation and/or learning of conjectures and associated depth; and (2) data-driven design of algorithmic mechanisms for exploring the conjectural equilibrium space by influencing the strategic agent(s) behaviors through adaptively adjusting and estimating deployed strategies.

As described herein, in the context of the current disclosure, a “game” between n agents is defined by
the set of players indexed by [symbol] ={1, . . . , n},
the action or strategy space of each player, namely Xᵢ for each i∈ [symbol] ; the system denotes the joint action or strategy space by X=X₁× . . . ×Xₙ, and
the cost function of each player, namely ƒᵢ:X→ [symbol] .

Each agent may seek to minimize its cost ƒᵢ with respect to its choice variable xᵢ. The cost function of agent i may depend on other agents' actions xⱼ∈ [symbol] \{i}. The system may use the notation x₋ᵢ=(x₁, . . . , xᵢ₋₁, xᵢ₊₁, . . . , xₙ) for all the actions excluding xᵢ. In some examples, the present methods and systems can be applied to dynamic games, including an environment in which the agents are interacting. The environment may include changes over time and may include definitions of states on which individual players' cost depends.

In some examples, the optimizer component 224 and the observer component 218 may leverage their associated components, the model(s) 232 and the data store 234, to build and evolve the models and rules for devices associated with the first agent(s) 104. The optimizer component 224 may use observed world data to generate updated device control law and update model(s) 232 as needed by the conjecture component 228, the strategy component 230, the estimator component 226, and the system and components. In various examples, the observer component 218, the optimizer component 224, and/or one or more associated components may be part of a standalone application that may be installed and stored on the first agent(s) 104.

In some examples, the optimizer component 224 and other components of the multi-agent conjectural system 206 may improve from the observed actions of the second agent(s) 106. The optimizer component 224 may define a two-player continuous game where players (e.g., the first age agent) have action spaces [symbol] ₁ and [symbol] ₂. Players have actions x₁∈ [symbol] ₁ and x₂∈ [symbol] ₂ and costs ƒ₁: [symbol] ₁× [symbol] ₂→ [symbol] and ƒ₂: [symbol] ₁× [symbol] ₂→ [symbol] . The system may define the superscript symbol “+” to represent actions at the next timestep. An individual player has its own partial derivative ∂₁ and ∂₂, which will be important when constructing gradient updates for both the human and machine.

The learning dynamics that players undergo may be derived from their costs and conjectures, wherein a Nash gradient play is

$${x}_{1}^{+} = {x}_{1} - {α}_{1} {\partial }_{1} {f}_{1} ( {x}_{1} , {x}_{2} ) \\ {x}_{2}^{+} = {x}_{2} - {α}_{2} {\partial }_{1} {f}_{2} ( {x}_{1} , {x}_{2} ) , {α}_{1} \approx {α}_{1} ,$$

where each player learns at approximately the same timescale. On the other hand, Stackelberg gradient play is

$${x}_{1}^{+} = {x}_{1} - {α}_{1} ( {\partial }_{1} {f}_{1} ( {x}_{1} {x}_{2} ) + {\partial }_{2} {f}_{1} ( {x}_{1} , {x}_{2} ) {L}_{2} ) \\ {x}_{2}^{+} = {x}_{2} - {α}_{2} {\partial }_{1} {f}_{2} ( {x}_{1} , {x}_{2} ) , {α}_{1} ≪ {α}_{2}$$

where the first player learns at a slower relative rate, and L₂ is calculated from the implicit function theorem assuming the second player solves to stationarity. By comparing the two pairs of learning rules, the system may generate the mathematical model of human/machine interaction based on gradients. To determine the kind of gradient descent that best models human behavior, the system may predict that the first pair of learning rules converge to Nash equilibria (NE) if they are stable. The optimization problems associated with Nash are

$${min}_{{x}_{1}} {f}_{1} ( {x}_{1} , {x}_{2} ) , \\ {min}_{{x}_{2}} {f}_{2} ( {x}_{1} , {x}_{2} ) ,$$

representing a simultaneous solution concept where both players choose an action without knowledge of each others responses. Additionally, the second pair of learning rules converge to stable Stackelberg equilibria, which are represented by optimization problems

$${min}_{{x}_{1}} {f}_{1} ( {x}_{1} , {r}_{2}^{( 0 )} ( {x}_{1} ) ) , \\ {min}_{{x}_{2}} {f}_{2} ( {x}_{1} , {x}_{2} ) ⇒ {x}_{2} = {r}^{( 0 )} ( {x}_{1} )$$

where r₂⁽⁰⁾(x₁) is the first players perfect knowledge of the second players response generated by solving the second player's optimization problem to convergence given a fixed action by the first player. The system may rewrite the first players problem as an equivalent constrained optimization problem

$${min}_{{x}_{1}} \{ {f}_{1} ( {x}_{1} , {x}_{2} ) \vert {x}_{2} = arg m {f}_{2} ( {x}_{1} , {x}_{2} ) \}$$

where the leader responds to the follower with the knowledge that the follower is performing best response without a model of the leader.

Given continuous costs, the system can determine the first-order and second-order stationary conditions for each equilibrium by analyzing the gradients. These may be similar to KKT conditions of single objective optimization problems and differ by either treating the opponent's action as a constant or as a function of player action. Accordingly, a differential Nash equilibrium has first-order conditions of

$$0 = {\partial }_{1} {f}_{1} ( {x}_{1} , {x}_{2} ) \\ 0 = {\partial }_{2} {f}_{2} ( {x}_{1} , {x}_{2} )$$

whereas a differential Stackelberg equilibrium has first-order conditions of

$$0 = {\partial }_{1} {f}_{1} ( {x}_{1} , {x}_{2} ) + {\partial }_{2} {f}_{1} ( {x}_{1} , {x}_{2} ) {L}_{2}^{0} \\ 0 = {\partial }_{2} {f}_{2} ( {x}_{1} , {x}_{2} )$$

where the bottom row is used to solve for x₂=r₂⁰(x₁), and the L₂⁰ is derived from L₂⁰=∂₁r₂⁰(x₁). This shows that for general costs, the Nash and Stackelberg equilibrium are distinct. Whether the first agent is capable of estimating this “L₂⁰” term determines whether the first agent can play as a leader in the game.

The estimator component 226 may include a method for the estimation of conjectural variations. The estimator component 226 may include the method and process of iteration to compute conjectural variations in the setting of the best response type conjectures. The present method integrates with a method for continual learning and adaptation. The method may utilize the first-order conjectural variations of an opponent to improve the individual's response and second-order conjectural variations and may verify whether the curvature of the agent's cost corresponds to a meaning equilibrium. During the continual improvement loop, agents can choose to explore the neighborhood of an equilibrium and model the opponent's response or exploit the model of their opponents response to improve their performance unilaterally by moving to the next level of the best response conjectural variations equilibrium.

The process of the conjectural iteration between agents can occur alternatively or simultaneously. However, due to the lack of coordination between non-cooperative agents, the estimator component 226 may presume there is a mix of both. The present example may focus on the alternating iteration, while the simultaneous method may be derived similarly.

The estimator component 226 may include a discrete iteration of an alternating improvement process that agents can employ. The system may focus on two-player games with quadratic costs, although it is understood that the system may generalize to games with more than two players or non-convex costs. The system may suppose agents begin with conjectures of each other: agent 1's conjecture of agent 2 is \hat{r}_{1→2}; agent 2's conjecture of agent 1 is \hat{r}_{2→1}.

The estimator component 226 may include alternating response improvement iteration: Agent 1 improves its response using its estimate of the opponent's conjectural variation. There is a completely analogous process for Agent 2.

Step 1A: Agent 1 forms an estimate of the variation of Agent 2's response [symbol] using t observations {x₂(τ)}_{τ=1}^{t} from Agent 2. Note that this process can also be formed in an online manner versus a batch setting.
Step 1B: Agent 1 may either optimize its cost using the estimated conjecture or run a learning algorithm for T steps:
Optimize: Agent 1 optimizes its cost:

$${min}_{{x}_{1}} {f}_{1} ( {x}_{1} , {\hat{r}}_{1 \to 2} ( {x}_{1} ) )$$

Solving this optimization problem may include finding an x₁∈X₁ such that

$${∇}_{1} {f}_{1} ( {x}_{1} , {x}_{2} ) + ∇ {\hat{r}}_{1 \to 2} ( {x}_{1} ) {∇}_{2} {f}_{1} ( {x}_{1} , {x}_{2} ) = 0$$

and ∇ₓ_{₁}²ƒ₁(x₁,\hat{r}_{1→2}(x₁))>0 where ∇ₓ_{₁}²(⋅) denotes the Hessian of ƒ₁(x₁,\hat{r}_{1→2}(x₁)) with respect to x₁ differentiating through \hat{r}_{1→2}(x₁), and x₂=\hat{r}_{1→2}(xᵢ).
Learn: Agent 1 employs a gradient-based learning algorithm for T steps such as policy gradient RL:

$${x}_{1}^{+} = {x}_{1} - η ( {∇}_{1} {f}_{1} ( {x}_{1} , {x}_{2} ) + {\hat{∇}}_{1 \to 2} ( {x}_{1} ) {∇}_{2} {f}_{1} ( {x}_{1} , {x}_{2} ) )$$

The estimator component 226 may include the following procedure outlines how to synthesize the mathematical map from the conjectural variation at level k to the conjectural variation at level k+1. Suppose two agents have a general form of quadratic costs given by

$${f}_{1} ( {x}_{1} , {x}_{2} ) = \frac{1}{2} {x}_{1}^{⊤} {A}_{1} {x}_{1} + {x}_{1}^{⊤} {B}_{1} {x}_{2} + \frac{1}{2} {x}_{2}^{⊤} {C}_{1} {x}_{2} \\ {f}_{2} ( {x}_{1} , {x}_{2} ) = \frac{1}{2} {x}_{2}^{⊤} {A}_{2} {x}_{2} + {x}_{2}^{⊤} {B}_{2} {x}_{1} + \frac{1}{2} {x}_{1}^{⊤} {C}_{2} {x}_{1}$$

The parameters (Aᵢ, Bᵢ, Cᵢ), i=1,2 are matrices where Aᵢ∈ [symbol] ^{d}^{ᵢ}^{×d}^{ᵢ} and Cᵢ∈ [symbol] ^{d}^{_{−i}}^{×d}^{_{−i}} are symmetric, but not necessarily definite, and Bᵢ is potentially rank deficient. Importantly, agent i's cost ƒᵢ is a function of both agents' actions x₁ and x₂, respectively. In this setting, agent conjectures are given by linear functions 3,

$${r}_{1 \to 2}^{( k )} ( {x}_{1} ) = {L}_{2} {x}_{1} \\ {r}_{2 \to 1}^{( k )} ( {x}_{2} ) = {L}_{1} {x}_{2}$$

which allows us to use the total derivatives of the agents' costs to compute the conjecture mapping between the spaces where Lᵢ and L₋ᵢ live. We derive the mapping as follows. First, observe that when player 2 conjectures about player 1, it forms a belief about how player 1 finds its optimal reaction given player 1's conjecture about player 2. That is, player 2 formulates or constructs its conjecture from the optimality conditions of the following optimization problem:

$${min}_{{x}_{1}} {f}_{1} ( {x}_{1} , {r}_{1 \to 2}^{( k )} ( {x}_{1} ) )$$

The first-order conditions of this problem are

$$\begin{matrix}∇ {f}_{1} ( {x}_{1} , {r}_{1 \to 2}^{( k )} ( {x}_{1} ) ) = {∇}_{1} {f}_{1} ( {x}_{1} , {x}_{2} ) + ∇ {{r}_{1 \to 2}^{( k )} ( {x}_{1} )}^{⊤} {∇}_{2} {f}_{1} ( {x}_{1} , {x}_{2} ) \\ = ( {A}_{1} + {L}_{2}^{⊤} {B}_{1}^{⊤} ) {x}_{1} + ( {B}_{1} + {L}_{2}^{⊤} {C}_{1} ) {x}_{2} = 0\end{matrix}$$

where in the first order conditions, the system may replace r_{1→2}^{(k)}(x₁) with x₂ to solve for x₁ in terms of x₂, which gives a mapping b₁(r_{1→2}^{(k)}(x₁)) from X₂ to X₁ defined by

$${b}_{1} ( {x}_{2} ) = - {( {A}_{1} + {L}_{2}^{⊤} {B}_{1}^{⊤} )}^{- 1} ( {B}_{1} + {L}_{2}^{⊤} {C}_{1} ) {x}_{2}$$

wherein b₁ is the best response map and/or the implicit function defined by the condition in (4). That is, it is the best response of player 1 to x₂ given that player 1 takes into consideration that x₂ is reacting to x₁ according to r_{1→2}^{(k)}. Because of the best response iterative structure, if r_{1→2}^{(k-1)} is used in the above analysis, this mapping is exactly r_{2→1}^{(k)}. That is, r_{2→1}^{(k)}≡b₁∘r_{1→2}^{(k-1)}. The system notes that this is an important observation that leads to the present method for not only estimating conjectures from data but also for constructing conjectures at higher levels of reasoning through composition.
Indeed, if the system defines the mapping h₁: [symbol] ^{d}^{₂}^{×d}^{₁}→ [symbol] ^{d}^{₁}^{×d}^{₂} by

$${h}_{1} ( {L}_{2} ) = - {( {A}_{1} + {L}_{2}^{⊤} {B}_{1}^{⊤} )}^{- 1} ( {B}_{1} + {L}_{2}^{⊤} {C}_{1} ) , \\ then \\ {L}_{1}^{( k + 1 )} = {h}_{1} ( {L}_{2}^{( k )} )$$

where here L₁^{(k)} is the matrix that defines the k-th level conjecture for player 2 about player 1, wherein

$${r}_{2 \to 1}^{( k )} ( {x}_{2} ) = {L}_{1}^{( k )} {x}_{2}$$

Taking the derivative of b₁(x₂) gives us the variation of r_{2→1}^{(k)} i.e.,

$$∇ {r}_{2 \to 1}^{( k )} ( {x}_{2} ) = - ( {A}_{1} + {L}_{2}^{⊤} {B}_{1}^{⊤} ) ( {B}_{1} + {L}_{2}^{⊤} {C}_{1} ) ∈ {ℝ}^{{d}_{1} \times {d}_{2}}$$

Analogously, player 1's conjecture and/or variation is constructed by examining the optimality conditions of the following problem:

$${min}_{{x}_{2}} {f}_{2} ( {r}_{2 \to 1}^{( k )} ( {x}_{2} ) , {x}_{2} )$$

Indeed, the first-order conditions are

$$\begin{matrix}0 = ∇ {f}_{2} ( {r}_{2 \to 1}^{( k )} ( {x}_{2} ) , {x}_{2} ) = {∇}_{2} {f}_{2} ( {x}_{1} , {x}_{2} ) + ∇ {{r}_{2 \to 1}^{( k )} ( {x}_{2} )}^{⊤} {∇}_{1} {f}_{2} ( {x}_{1} , {x}_{2} ) \\ = ( {A}_{2} + {L}_{1}^{⊤} {B}_{2}^{⊤} ) {x}_{2} + ( {B}_{2} + {L}_{1}^{⊤} {C}_{2} ) {x}_{1}\end{matrix}$$

As described above, if the system solves for x₂ in terms of x₁, the result includes the mapping b₂(r_{2→1}^{(k)}(x₂)) which is defined by

$${b}_{2} ( {x}_{1} ) = - {( {A}_{2} + {L}_{1}^{⊤} {B}_{2}^{⊤} )}^{- 1} ( {B}_{2} + {L}_{1}^{⊤} {C}_{2} ) {x}_{1}$$

In some examples, the optimizer component 224 may train one or more models. As described herein, the multi-agent conjectural system 206 and associated components may receive and store data from observed actions of a first agent and observed reactions of a second agent, and this may be received over a predetermined time period. The optimizer component 224 may generate training data from the stored data and may train one or more ML model(s) 232 with the training data. The one or more ML model(s) 232 may include a cost model and/or a conjecture model. The cost model may determine estimated costs associated with actions (or reactions) taken by the second agent. The conjectural model may predict a reaction of a second agent in response to an action of a first agent. In some examples, the conjectural model may determine conjectural probabilities for predicted responses associated with the second agent, and the optimizer component 224 may use the conjectural probabilities to determine an objective response from the predicted responses. The optimizer component 224 may generate the cost model and/or the conjectural model by generating action maps for the first agent and the second agent. In some examples, the optimizer component 224 may generate the conjectural model based on an estimated cost model or a known cost model. In additional and/or alternative examples, the optimizer component 224 may generate the conjectural model using training data received from observations of the world. In some examples, the optimizer component 224 may use the output objective to determine a desired outcome and use the conjectural model to determine an action (“conjectural action”) for the first agent to take to cause the second agent to perform a predicted reaction (“conjectural reaction”) for the desired outcome. An “action” taken by a first agent, which may include any device interacting with a user, may include changing a control parameter on the device. For example, a rehabilitation exoskeleton device may gradually decrease the amount of support it provides to a user to cause the user to support themselves more over a time period. After the first agent performs the conjectural action, the multi-agent conjectural system 206 and associated components may receive data (from sensors and/or other observation means) associated with the actual reaction performed by the second agent. The optimizer component 224 may determine a difference between the conjectural reaction and the actual reaction performed by the second agent and may use the difference to train one or more updated models.

In various examples, the system may train one or more ML model(s) 232 using observed data as training data. As described herein, this observed user reaction and predicted reaction is used to generate training data to improve the model(s) 232 for the multi-agent conjectural system 206. Machine learning generally involves processing a set of examples (called “training data”) to train one or more ML model(s) 232. The model(s) 232, once trained, is a learned mechanism that can receive new data as input and estimate or predict a result as output. Additionally, the model(s) 232 may output a confidence score associated with the predicted result. The confidence score may be determined using probabilistic classification and/or weighted classification. For example, a trained ML model(s) 232 can comprise a classifier that is tasked with classifying unknown input as one of the multiple class labels. In additional examples, the model(s) 232 can be retrained with additional and/or new training data labeled with one or more new types (e.g., rules) to teach the model(s) 232 to classify unknown input by types that may now include the one or more new types.

In additional and/or alternative examples, the ML model(s) 232 may include a generative model, which is a statistical model that can generate new data instances. Generative modeling generally involves performing statistical modeling on a set of data instances X and a set of labels Y in order to determine the joint probability p(X, Y) or the joint probability distribution on X×Y. In various examples, the statistical model may use neural network models to learn an algorithm to approximate the model distribution. In some examples, the generative model may be trained to receive input conditions as context and may output a full or partial rule. In an additional example, the generative model may include a confidence calibrator which may output the confidence associated with the rule generated by the generative model. As described herein, the optimizer component 224 may model interaction as a dynamic system. The agents are modeled to perform updates based on actions and observations; then, the system determines the convergence of the dynamics to equilibria and limit cycles. The system applies game theory methods to analyze learning dynamics and synthesize learning algorithms for human-machine interaction.

In the context of the present disclosure, the input may include data that is to be handled according to its context, and the trained ML model(s) 232 may be tasked with receiving input parameters and outputting a conjecture that connects the input goal with the context. For instance, as described herein, the system may use a model human-machine interaction as a two-player continuous game with continuous action spaces and smooth cost functions. The system may analyze the game theoretic predictions of equilibrium interaction.

In some examples, the trained ML model(s) 232 may classify an input query with context as relevant to one of the inference rules and determine an associated confidence score. In various examples, if the trained ML model(s) 232 has low confidence (e.g., a confidence score is at or below a low threshold) in its proof for an explanation to an input query, this low confidence may return no rules found. An extremely high confidence score (e.g., a confidence score is at or exceeds a high threshold) may indicate the rule is proof for an input query. After the inference rule has been applied to an explanation, the data with the inference rules may be labeled as correct or incorrect by a user, and the data may be used as additional training data to retrain the model(s) 232. Thus, the system may retrain the ML model(s) 232 with the additional training data to generate the new ML model(s) 232. The new ML model(s) 232 may be applied to new inference rules as a continuous retraining cycle to improve the rules generator.

The ML model(s) 232 may represent a single model or an ensemble of base-level ML models and may be implemented as any type of model(s) 232. For example, suitable ML model(s) 232 for use with the techniques and systems described herein include, without limitation, tree-based models, k-Nearest Neighbors (kNN), support vector machines (SVMs), kernel methods, neural networks, random forests, splines (e.g., multivariate adaptive regression splines), hidden Markov model (HMMs), Kalman filters (or enhanced Kalman filters), Bayesian networks (or Bayesian belief networks), expectation-maximization, genetic algorithms, linear regression algorithms, nonlinear regression algorithms, logistic regression-based classification models, linear discriminant analysis (LDA), generative models, discriminative models, or an ensemble thereof. An “ensemble” can comprise a collection of the model(s) 232 whose outputs are combined, such as by using weighted averaging or voting. The individual ML models of an ensemble can differ in their expertise, and the ensemble can operate as a committee of individual ML models that are collectively “smarter” than any individual machine learning model of the ensemble.

The data store 234 may store at least some data including, but not limited to, data collected from the multi-agent conjectural system 206, including the agent manager component 210, the domain design component 212, the observer component 218, the optimizer component 224, and the model(s) 232, including data associated with domain data, localized information, world data, conjecture data, agent models, and world models. In some examples, the data may be automatically added via a computing device (e.g., the computing device(s) 102, the first agent(s) 104). The domain data may include domain parameters and generated observation data. Training data may include any portion of the data in the data store 234 that is selected to be used to train one or more ML models. In additional and/or alternative examples, at least some of the data may be stored in a storage system or other data repository.

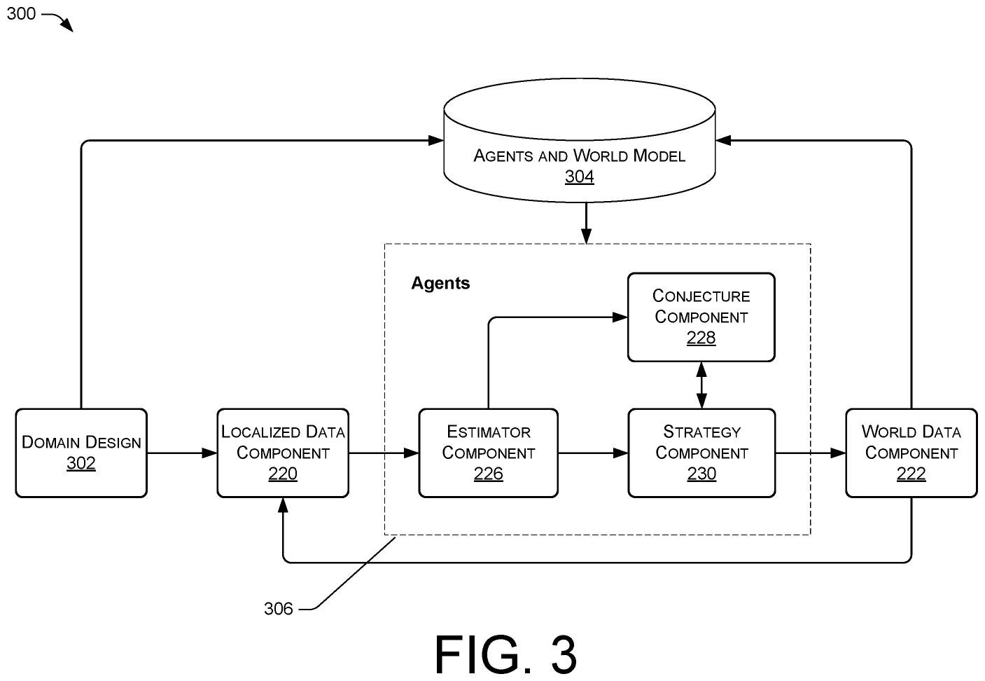

FIG. 3 illustrates an example implementation 300 of components and models that may be configured to be used with a multi-agent conjectural system. The select components may include the localized data component 220, the estimator component 226, the conjecture component 228, and the strategy component 230. As described herein, the example data flow includes an example domain design 302 and example agents and world model 304, and an example agent framework 306 is situated within a world.

The data flow may initiate based on the system receiving the example domain design 302. In some instances, the example domain design 302 can correspond to the domain design component 114 of FIG. 1 and the domain design component 212 of FIG. 2. The example domain design 302 may receive designs for one or more area domains. For any area domain, the example domain design 302 may include data associated with the design including, but not limited to, a first agent, a second agent, any data including input, output, initial parameters and/or constants, parameters to measure during the game, conjecture variables, performance threshold, depth level tolerance, and the like. An agent may start by collecting data associated with observations of the world by collecting data associated with the localized data component 220 and the world data component 222.

The agent framework 306 includes an agent that may use the observations to update the example agents and world model 304 based on a strategy that optimizes for individual cost/reward. For instance, the estimator component 226 may receive the data and estimate a cost model for the opponent. The conjecture component 228 may receive the data and determine a conjecture model for the opponent. In some examples, the conjecture component 228 may receive the cost model and determine a conjecture model for the opponent. The strategy component 230 may observe conjecture and the actual action of the opponent and determine to update any cost model and/or conjecture model.

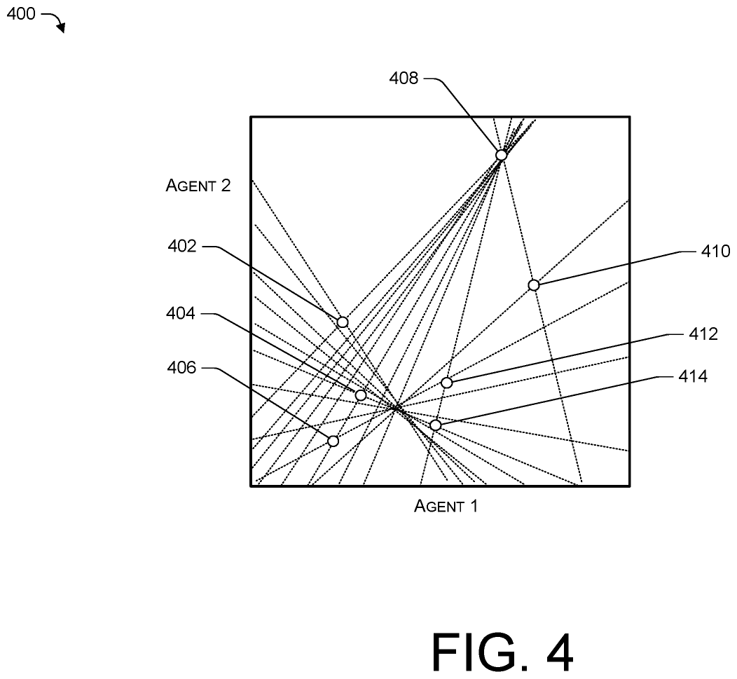

FIG. 4 illustrates an example data mapping 400 for the decision landscape of agents in a scalar quadratic game, as discussed herein.

As described herein, the optimizer component 224 may include the conjecture component 228 and the strategy component 230. In various examples, the optimizer component 224 and associated components may include a scalar quadratic game illustrating mapping actions to compute conjectures. The game may include decision variables that are drawn from vector spaces, and the costs are quadratic functions of the decision variables, wherein the optimal strategy for each agent is affine: uᵢ⁺=Lᵢ⁻ⁱu₋ᵢ+aᵢ; in this case, the system may regard uᵢ∈ [symbol] ^{d}^{ᵢ} for each i∈I, so Lᵢ⁻ⁱ∈ [symbol] ^{d}^{ᵢ}^{×d}^{_{−i}} where d₋ᵢ=Σ_{j∈-i}dⱼ.

Agent i will compute their conjecture \hat{L}₋ᵢⁱ, and â₋ᵢⁱ using regression (e.g., least-squares, possibly via ordinary, weighted, recursive, or robust variants).

Agent i will use associated conjectures to determine and associate data-driven best response uᵢ=Lᵢ⁻ⁱu₋ᵢ+aᵢ conditioned on its conjectures about the other agents by solving a system of linear equations. The system may include an algorithm wherein both agents compute estimates of the other's response and use that estimate as their conjecture, converging to the consistent conjectural variation equilibrium.

In some instances, the example data mapping 400 may illustrate the decision landscape of agents in a scalar quadratic game, wherein for each player, there are, in total, seven distinct equilibria. The example point 402 illustrates a consistent conjectural variation equilibrium (CCVE). The example point 404 illustrates a Stackelberg equilibria (SE) for agent 2. The example point 406 illustrates a Nash equilibrium (NE). The example point 408 illustrates reverse Stackelberg equilibria (RSE) for agent 1. The example point 410 illustrates double reverse Stackelberg equilibria for agent 2. The example point 412 illustrates a Stackelberg equilibria (SE) for agent 1. The example point 414 illustrates double Stackelberg equilibria for agent 2.

FIGS. 5-11 are flow diagrams of illustrative processes. The example processes are described in the context of the environment of FIG. 2 but are not limited to that environment. The processes are illustrated as a collection of blocks in a logical flow graph, which represents a sequence of operations that can be implemented in hardware, software, or a combination thereof. In the context of software, the blocks represent computer-executable instructions stored on one or more computer-readable media 204 that, when executed by one or more processors 202, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes. The processes discussed below may be combined in any way to create derivative processes that are still within the scope of this disclosure.

FIG. 5 illustrates an example process 500 for a multi-agent conjectural system to optimize decision-making for a first agent, as discussed herein. The process 500 is described with reference to the system 100 and may be performed by one or more of the computing device(s) 102 and/or in cooperation with any one or more of the devices associated with the first agent(s) 104. Of course, the process 500 (and other processes described herein) may be performed in other similar and/or different environments.

At operation 502, the process may include receiving data associated with an input parameter and an output objective for an area domain. For instance, the computing device(s) 102 or the first agent(s) 104 may receive data associated with an input parameter and an output objective for an area domain. The system may determine an area domain of interest based on a device associated with the first agent(s) 104 or based on data received from a device a user is operating. The system may send data associated with the domain design, including input parameters and output objectives, to the device. The system and/or the device may receive data associated with the input parameter and/or the output objective.

At operation 504, the process may include generating training data based at least in part on observed actions of a first agent and observed reactions of a second agent over a predetermined time period, wherein the first agent comprises a device and the second agent comprises a human user. For instance, the computing device(s) 102 or the first agent(s) 104 may generate training data based at least in part on observed actions of a first agent and observed reactions of a second agent over a predetermined time period, wherein the first agent comprises a device and the second agent comprises a human user. The system may receive and store data from observed actions of a first agent and observed reactions of a second agent, and this may be received over a predetermined time period. The system may generate training data from the stored data and may train one or more ML.

At operation 506, the process may include generating, based at least in part on the training data, a conjectural model, wherein the conjectural model predicts a reaction of the second agent in response to an action of the first agent. For instance, the computing device(s) 102 or the first agent(s) 104 may generate, based at least in part on the training data, a conjectural model, wherein the conjectural model predicts a reaction of the second agent in response to an action of the first agent. The system may generate training data from the stored data and may train one or more ML, including a cost model and/or conjecture model. The conjectural model may predict a reaction of a second agent in response to an action of a first agent.

At operation 508, the process may include determining, based at least in part on the output objective and the conjectural model, a conjectural action for the first agent to generate a predicted reaction from the second agent. For instance, the computing device(s) 102 or the first agent(s) 104 may determine, based at least in part on the output objective and the conjectural model, a conjectural action for the first agent to generate a predicted reaction from the second agent. The system may use the output objective to determine a desired outcome and use the conjectural model to determine an action for the first agent to take to cause the second agent to perform a predicted reaction for the desired outcome.

At operation 510, the process may include receiving, from the device, observed data associated with the second agent. For instance, the computing device(s) 102 or the first agent(s) 104 may receive, from the device, observed data associated with the second agent. The system may receive and store data from observed actions of a first agent and observed reactions of a second agent, and this may be received over a predetermined time period

At operation 512, the process may include generating, based at least in part on the observed data and the output objective, an updated conjectural model. For instance, the computing device(s) 102 or the first agent(s) 104 may generate, based at least in part on the observed data and the output objective, an updated conjectural model. The operations may return to operation 508. The system may use the output objective to determine a desired outcome and use the conjectural model to determine an action (“conjectural action”) for the first agent to take to cause the second agent to perform a predicted reaction (“conjectural reaction”) for the desired outcome. After the first agent performs the conjectural action, the system may receive data associated with the actual reaction performed by the second agent. The system may determine a difference between the conjectural reaction and the actual reaction performed by the second agent and may use the difference to train one or more updated models including an updated.

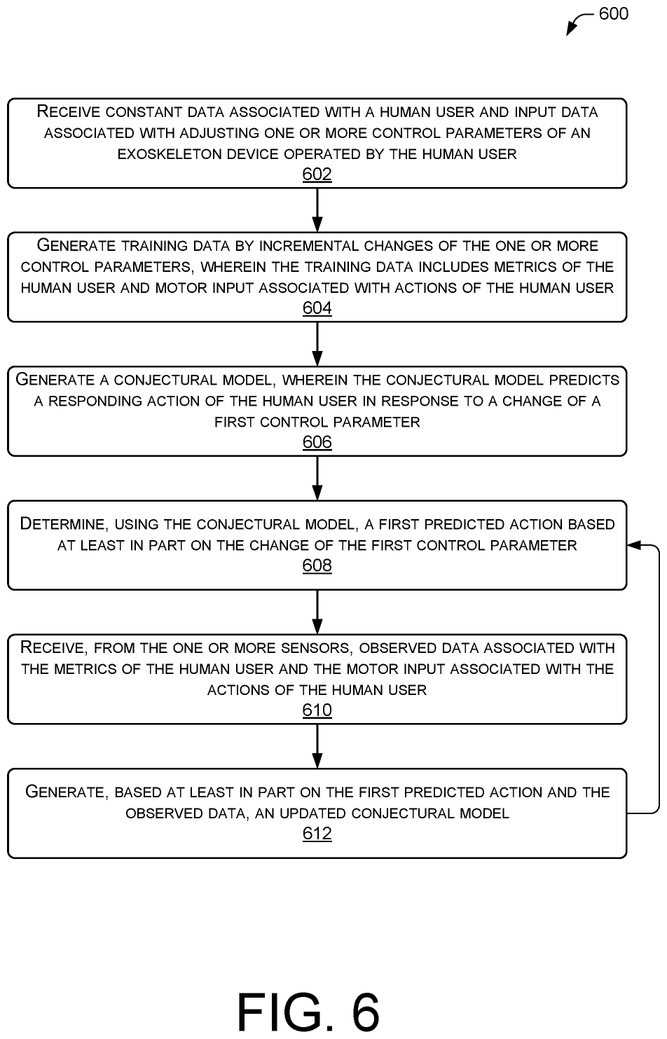

FIG. 6 illustrates another example process 600 for a multi-agent conjectural system to optimize decision-making for a first agent, as discussed herein. The process 600 is described with reference to the system 100 and may be performed by one or more of the computing device(s) 102 and/or in cooperation with any one or more of the devices associated with the first agent(s) 104. Of course, the process 600 (and other processes described herein) may be performed in other similar and/or different environments.

At operation 602, the process may include receiving constant data associated with a human user and input data associated with adjusting one or more control parameters of an exoskeleton device operated by the human user. For instance, the computing device(s) 102 or the first agent(s) 104 may receive constant data associated with a human user and input data associated with adjusting one or more control parameters of an exoskeleton device operated by the human user. The system may determine an area domain of interest based on a device associated with the first agent(s) 104 or based on data received from a device a user is operating. The system may send data associated with the domain design, including input parameters and output objectives, to the device. The system and/or the device may receive data associated with the input parameter and/or the output objective. The system may send or receive constant data associated with a human user and input data associated with adjusting one or more control parameters of an exoskeleton device operated by the human user.

At operation 604, the process may include generating training data by incremental changes of the one or more control parameters, wherein the training data includes metrics of the human user and motor input associated with actions of the human user. For instance, the computing device(s) 102 or the first agent(s) 104 may generate training data by incremental changes of the one or more control parameters, wherein the training data includes metrics of the human user and motor input associated with actions of the human user. As described herein, the system may receive and store data from observed actions of a first agent and observed reactions of a second agent and this may be received over a predetermined time period. The system may generate training data from the stored data and may train one or more ML model(s) with the training data including a conjecture model. The cost model may determine estimated costs associated with actions (or reactions) taken by the second agent. The conjectural model may predict a reaction of a second agent in response to an action of a first agent. The system may generate the conjectural model by generating action maps for the first agent and the second agent. In some examples, the system may generate the conjectural model using training data received from observations of the world. In some examples, the system may use the output objective to determine a desired outcome and use the conjectural model to determine an action (“conjectural action”) for the first agent to take to cause the second agent to perform a predicted reaction (“conjectural reaction”) for the desired outcome. An “action” taken by a first agent, which may include any device interacting with a user, may include changing a control parameter on the device. For examples, a rehabilitation exoskeleton device may gradually decrease an amount of support it provides to a user to cause the user to support themselves more over a time period.

At operation 606, the process may include generating a conjectural model, wherein the conjectural model predicts a responding action of the human user in response to a change of a first control parameter. For instance, the computing device(s) 102 or the first agent(s) 104 may generate a conjectural model, wherein the conjectural model predicts a responding action of the human user in response to a change of a first control parameter. The system may generate the conjectural model by generating action maps for the first agent and the second agent.

At operation 608, the process may include determining, using the conjectural model, a first predicted action based at least in part on the change of the first control parameter. For instance, the computing device(s) 102 or the first agent(s) 104 may determine, using the conjectural model, a first predicted action based at least in part on the change of the first control parameter. The system may use the output objective to determine a desired outcome and use the conjectural model to determine an action (“conjectural action”) for the first agent to take to cause the second agent to perform a predicted reaction (“conjectural reaction”) for the desired outcome. An “action” taken by a first agent, which may include any device interacting with a user, may include changing a control parameter on the device. For examples, a rehabilitation exoskeleton device may gradually decrease an amount of support it provides to a user to cause the user to support themselves more over a time period.

At operation 610, the process may include receiving, from the one or more sensors, observed data associated with the metrics of the human user and the motor input associated with the actions of the human user. For instance, the computing device(s) 102 or the first agent(s) 104 may receive, from the one or more sensors, observed data associated with the metrics of the human user and the motor input associated with the actions of the human user. After the first agent performs the conjectural action, the system may receive data, from sensors and/or other observation means, associated with the actual reaction performed by the second agent. The system may determine a difference between the conjectural reaction and the actual reaction performed by the second agent and may use the difference to train one or more updated models.

At operation 612, the process may include generating based at least in part on the first predicted action and the observed data, an updated conjectural model. For instance, the computing device(s) 102 or the first agent(s) 104 may generate, based at least in part on the first predicted action and the observed data, an updated conjectural model. The operations may return to the operation 608. As described herein, the system may determine a difference between the conjectural reaction and the actual reaction performed by the second agent and may use the difference to train one or more updated models.

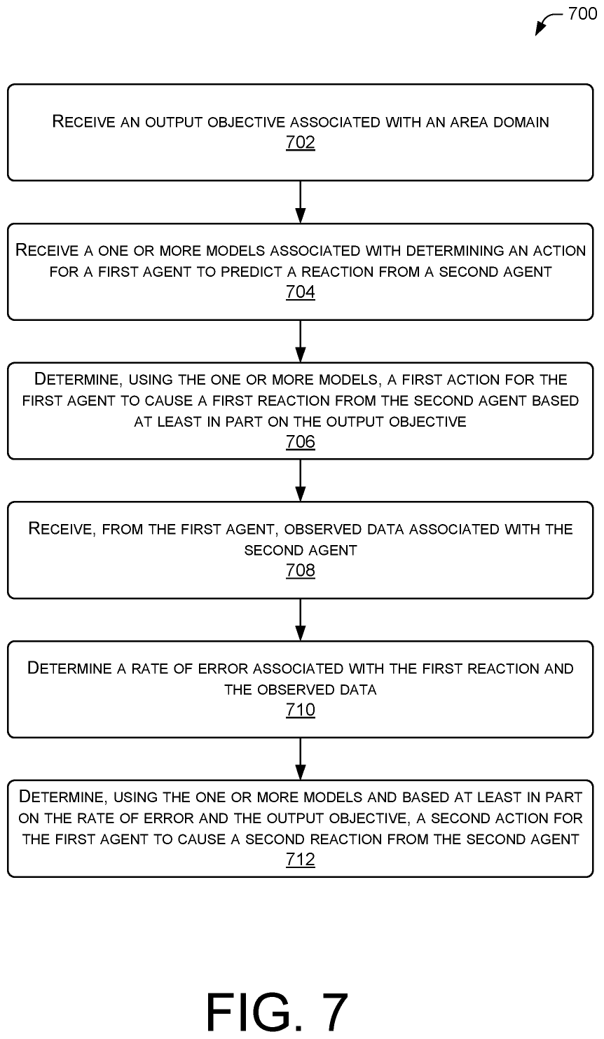

FIG. 7 illustrates another example process 700 for a multi-agent conjectural system to optimize decision-making for a first agent, as discussed herein. The process 700 is described with reference to the system 100 and may be performed by one or more of the computing device(s) 102 and/or in cooperation with any one or more of the devices associated with the first agent(s) 104. Of course, the process 700 (and other processes described herein) may be performed in other similar and/or different environments.

At operation 702, the process may include receiving an output objective associated with a knowledge domain. For instance, the computing device(s) 102 or the first agent(s) 104 may receive an output objective associated with a knowledge domain.

At operation 704, the process may include receiving a one or more models associated with determining an action for a first agent to predict a reaction from a second agent. For instance, the computing device(s) 102 or the first agent(s) 104 may receive a one or more models associated with determining an action for a first agent to predict a reaction from a second agent.

At operation 706, the process may include determining, using the one or more models, a first action for the first agent to cause a first reaction from the second agent based at least in part on the output objective. For instance, the computing device(s) 102 or the first agent(s) 104 may determine, using the one or more models, a first action for the first agent to cause a first reaction from the second agent based at least in part on the output objective.

At operation 708, the process may include receiving, from the first agent, observed data associated with the second agent. For instance, the computing device(s) 102 or the first agent(s) 104 may receive, from the first agent, observed data associated with the second agent.

At operation 710, the process may include determining a rate of error associated with the first reaction and the observed data. For instance, the computing device(s) 102 or the first agent(s) 104 may determine a rate of error associated with the first reaction and the observed data.

At operation 712, the process may include determining, using the one or more models and based at least in part on the rate of error and the output objective, a second action for the first agent to cause a second reaction from the second agent. For instance, the computing device(s) 102 or the first agent(s) 104 may determine, using the one or more models and based at least in part on the rate of error and the output objective, a second action for the first agent to cause a second reaction from the second agent. The system may

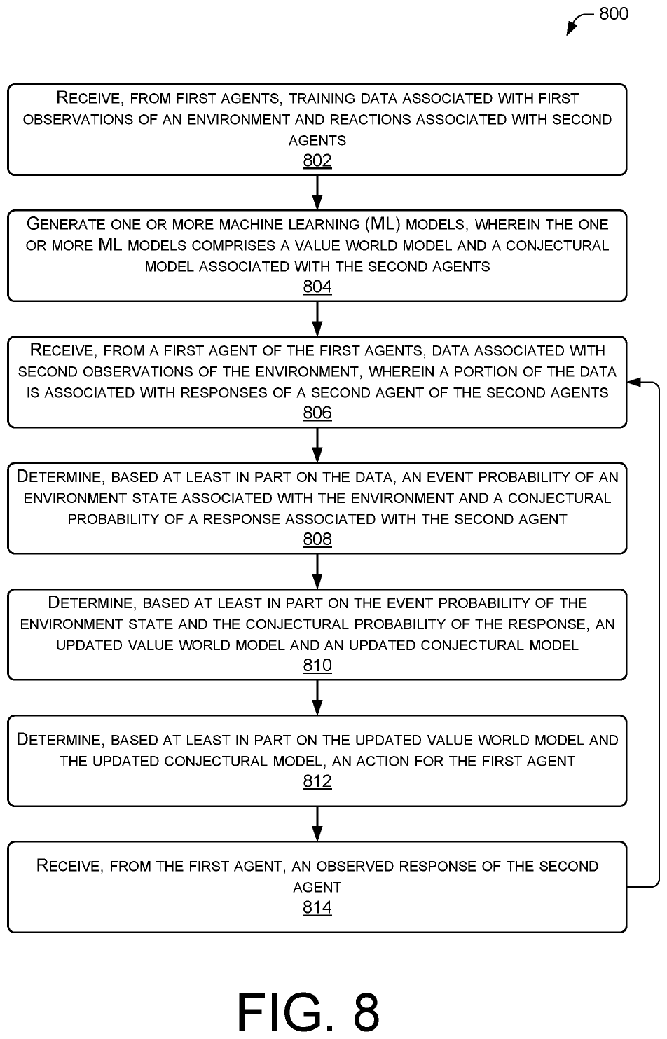

FIG. 8 illustrates another example process 800 for a multi-agent conjectural system to optimize decision-making for a first agent, as discussed herein. The process 800 is described with reference to the system 100 and may be performed by one or more of the computing device(s) 102 and/or in cooperation with any one or more of the devices associated with the first agent(s) 104. Of course, the process 800 (and other processes described herein) may be performed in other similar and/or different environments.

At operation 802, the process may include receiving, from first agents, training data associated with first observations of an environment and reactions associated with second agents. For instance, the computing device(s) 102 or the first agent(s) 104 may receive, from first agents, training data associated with first observations of an environment and reactions associated with second agents.

At operation 804, the process may include generating one or more machine learning (ML) models, wherein the one or more ML models comprises a value world model and a conjectural model associated with the second agents. For instance, the computing device(s) 102 or the first agent(s) 104 may generate one or more machine learning (ML) models, wherein the one or more ML models comprises a value world model and a conjectural model associated with the second agents.

At operation 806, the process may include receiving, from a first agent of the first agents, data associated with second observations of the environment, wherein a portion of the data is associated with responses of a second agent of the second agents. For instance, the computing device(s) 102 or the first agent(s) 104 may receive, from a first agent of the first agents, data associated with second observations of the environment, wherein a portion of the data is associated with responses of a second agent of the second agents.

At operation 808, the process may include determining, based at least in part on the data, an event probability of an environment state associated with the environment and a conjectural probability of a response associated with the second agent. For instance, the computing device(s) 102 or the first agent(s) 104 may determine, based at least in part on the data, an event probability of an environment state associated with the environment and a conjectural probability of a response associated with the second agent.

At operation 810, the process may include determining, based at least in part on the event probability of the environment state and the conjectural probability of the response, an updated value world model and an updated conjectural model. For instance, the computing device(s) 102 or the first agent(s) 104 may determine, based at least in part on the event probability of the environment state and the conjectural probability of the response, an updated value world model and an updated conjectural model.

At operation 812, the process may include determining, based at least in part on the updated value world model and the updated conjectural model, an action for the first agent. For instance, the computing device(s) 102 or the first agent(s) 104 may determine, based at least in part on the updated value world model and the updated conjectural model, an action for the first agent.

At operation 814, the process may include receiving, from the first agent, an observed response of the second agent. For instance, the computing device(s) 102 or the first agent(s) 104 may receive, from the first agent, an observed response of the second agent. The operations may return to the operation 806.

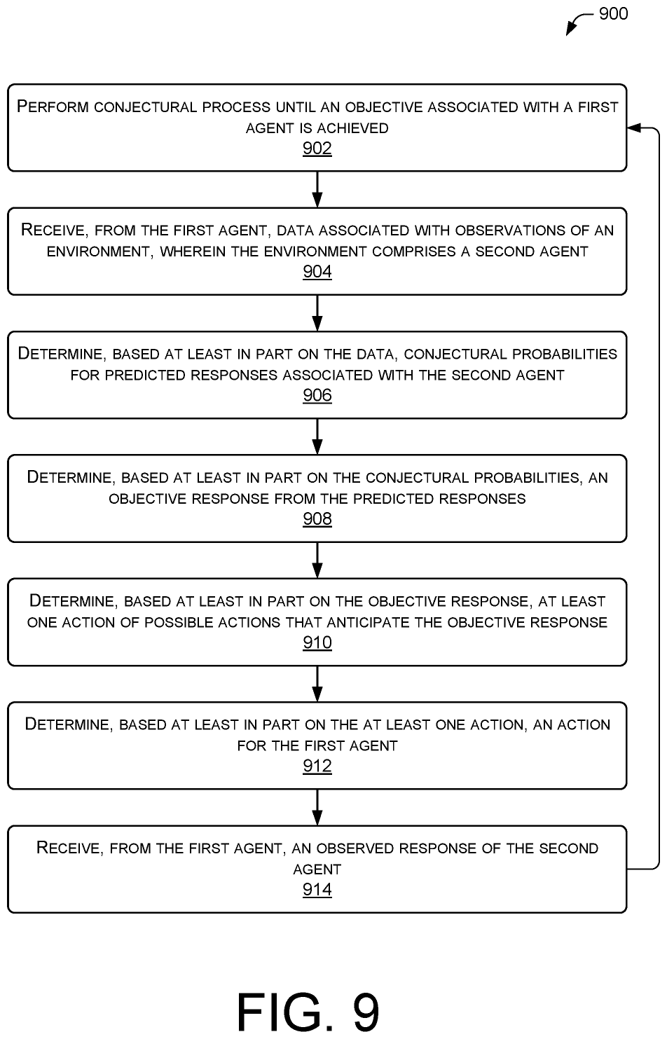

FIG. 9 illustrates another example process 900 for a multi-agent conjectural system to optimizing decision-making with objectives, as discussed herein. The process 900 is described with reference to the system 100 and may be performed by one or more of the computing device(s) 102 and/or in cooperation with any one or more of the devices associated with the first agent(s) 104. Of course, the process 900 (and other processes described herein) may be performed in other similar and/or different environments.

At operation 902, the process may include performing conjectural process until an objective associated with a first agent is achieved. For instance, the computing device(s) 102 or the first agent(s) 104 may perform conjectural process until an objective associated with a first agent is achieved.

At operation 904, the process may include receiving, from the first agent, data associated with observations of an environment, wherein the environment comprises a second agent. For instance, the computing device(s) 102 or the first agent(s) 104 may receive, from the first agent, data associated with observations of an environment, wherein the environment comprises a second agent.

At operation 906, the process may include determining, based at least in part on the data, conjectural probabilities for predicted responses associated with the second agent. For instance, the computing device(s) 102 or the first agent(s) 104 may determine, based at least in part on the data, conjectural probabilities for predicted responses associated with the second agent.

At operation 908, the process may include determining, based at least in part on the conjectural probabilities, an objective response from the predicted responses. For instance, the computing device(s) 102 or the first agent(s) 104 may determine, based at least in part on the conjectural probabilities, an objective response from the predicted responses.

At operation 910, the process may include determining, based at least in part on the objective response, at least one action of the possible actions that anticipate the objective response. For instance, the computing device(s) 102 or the first agent(s) 104 may determine, based at least in part on the objective response, at least one action of the possible actions that anticipate the objective response.

At operation 912, the process may include determining, based at least in part on the at least one action, an action for the first agent. For instance, the computing device(s) 102 or the first agent(s) 104 may determine, based at least in part on the at least one action, an action for the first agent.

At operation 914, the process may include receiving, from the first agent, an observed response of the second agent. For instance, the computing device(s) 102 or the first agent(s) 104 may receive, from the first agent, an observed response of the second agent. The operations may return to operation 902.

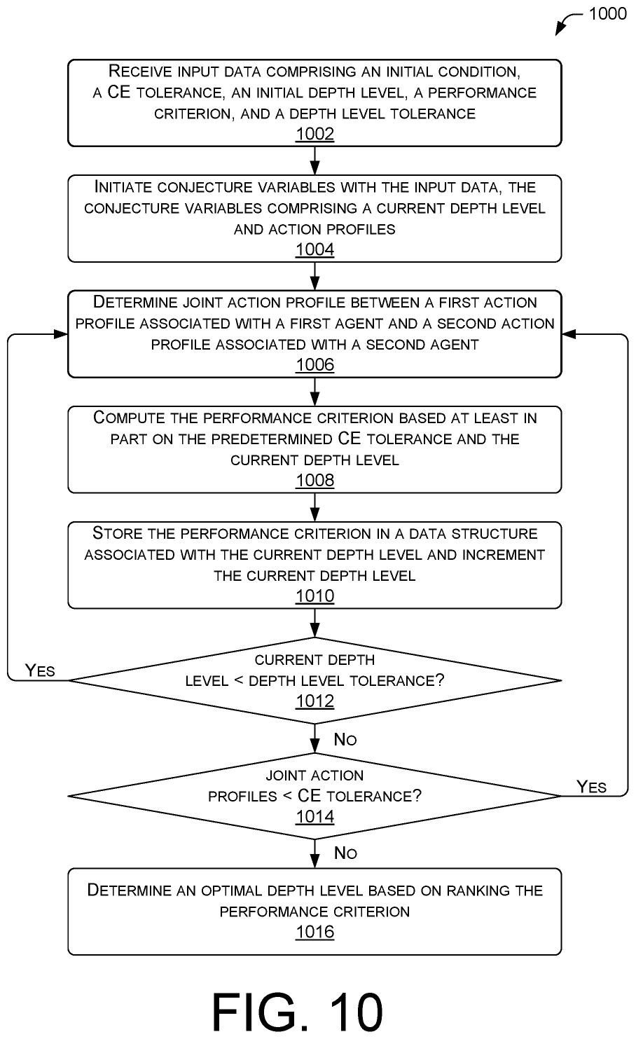

FIG. 10 illustrates an example process 1000 for a multi-agent conjectural system to learn conjectures, as discussed herein. The process 1000 is described with reference to the system 100 and may be performed by one or more of the computing device(s) 102 and/or in cooperation with any one or more of the devices associated with the first agent(s) 104. Of course, the process 1000 (and other processes described herein) may be performed in other similar and/or different environments.

At operation 1002, the process may include receiving input data comprising an initial condition, a CE tolerance, an initial depth level, a performance criterion, and a depth level tolerance. For instance, the computing device(s) 102 or the first agent(s) 104 may receive input data comprising an initial condition, a CE tolerance, an initial depth level, a performance criterion, and a depth level tolerance.

At operation 1004, the process may include initiating conjecture variables with the input data, the conjecture variables comprising a current depth level and action profiles. For instance, the computing device(s) 102 or the first agent(s) 104 may initiate conjecture variables with the input data, the conjecture variables comprising a current depth level and action profiles.

At operation 1006, the process may include determining joint action profile between a first action profile associated with a first agent and a second action profile associated with a second agent. For instance, the computing device(s) 102 or the first agent(s) 104 may determine joint action profile between a first action profile associated with a first agent and a second action profile associated with a second agent. The system may map the actions of a first agent relative to actions (or reactions) of a second agent to generate a joint action profile.

At operation 1008, the process may include computing the performance criterion based at least in part on the predetermined CE tolerance and the current depth level. For instance, the computing device(s) 102 or the first agent(s) 104 may compute the performance criterion based at least in part on the predetermined CE tolerance and the current depth level.

At operation 1010, the process may include storing the performance criterion in a data structure associated with the current depth level and increment the current depth level. For instance, the computing device(s) 102 or the first agent(s) 104 may store the performance criterion in a data structure associated with the current depth level and increment the current depth level.

At operation 1012, the process may include determining if the current depth level is less than the depth level tolerance. For instance, the computing device(s) 102 or the first agent(s) 104 may determine if the current depth level is less than the depth level tolerance. If the system determines that the current depth level is less than the depth level tolerance, the operations return the operation 1006. Otherwise, the operations advance to operation 1014.

At operation 1014, the process may include determining if the joint action is less than the CE tolerance. For instance, the computing device(s) 102 or the first agent(s) 104 may determine if the joint action is less than the CE tolerance. If the system determines that the joint action is less than the CE tolerance, the operations return the operation 1006. Otherwise, the operations advance to operation 1016.

At operation 1016, the process may include determining an optimal depth level based on ranking the performance criterion. For instance, the computing device(s) 102 or the first agent(s) 104 may determine an optimal depth level based on ranking the performance criterion.

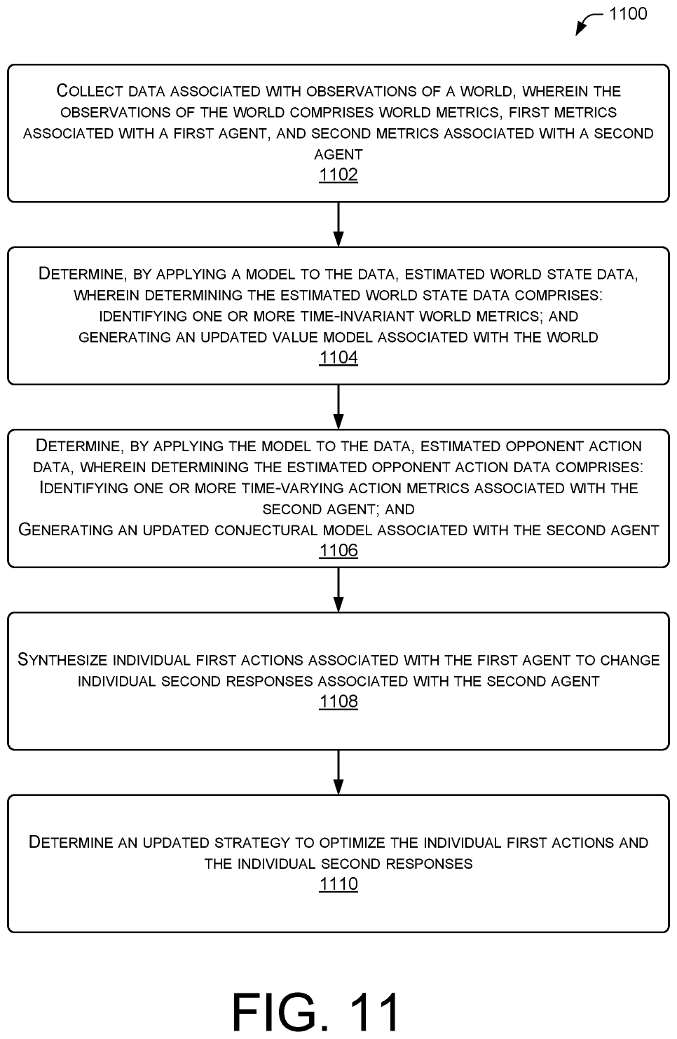

FIG. 11 illustrates an example process 1100 for a multi-agent conjectural system to synthesize optimal interactions between agents, as discussed herein. The process 1100 is described with reference to the system 100 and may be performed by one or more of the computing device(s) 102 and/or in cooperation with any one or more of the devices associated with the first agent(s) 104. Of course, the process 1100 (and other processes described herein) may be performed in other similar and/or different environments.

At operation 1102, the process may include collecting data associated with observations of a world, wherein the observations of the world comprises world metrics, first metrics associated with a first agent, and second metrics associated with a second agent. For instance, the computing device(s) 102 or the first agent(s) 104 may collect data associated with observations of a world, wherein the observations of the world comprises world metrics, first metrics associated with a first agent, and second metrics associated with a second agent.

At operation 1104, the process may include determining, by applying a model to the data, estimated world state data, wherein determining the estimated world state data comprises: identifying one or more time-invariant world metrics; and generating an updated value model associated with the world. For instance, the computing device(s) 102 or the first agent(s) 104 may determine, by applying a model to the data, estimated world state data, wherein determining the estimated world state data comprises: identifying one or more time-invariant world metrics; and generating an updated value model associated with the world.

At operation 1106, the process may include determining, by applying the model to the data, estimated opponent action data, wherein determining the estimated opponent action data comprises: identifying one or more time-varying action metrics associated with the second agent; and generating an updated conjectural model associated with the second agent. For instance, the computing device(s) 102 or the first agent(s) 104 may determine, by applying the model to the data, estimated opponent action data, wherein determining the estimated opponent action data comprises: identifying one or more time-varying action metrics associated with the second agent; and generating an updated conjectural model associated with the second agent.

At operation 1108, the process may include synthesizing individual first actions associated with the first agent to change individual second responses associated with the second agent. For instance, the computing device(s) 102 or the first agent(s) 104 may synthesize individual first actions associated with the first agent to change individual second responses associated with the second agent.

At operation 1110, the process may include determining an updated strategy to optimize the individual first actions and the individual second responses. For instance, the computing device(s) 102 or the first agent(s) 104 may determine an updated strategy to optimize the individual first actions and the individual second responses.

### Example Clauses

Various examples include one or more of, including any combination of any number of, the following example features. Throughout these clauses, parenthetical remarks are for example and explanation, and are not limiting. Parenthetical remarks given in this Example Clauses section with respect to specific language apply to corresponding language throughout this section, unless otherwise indicated.

A: One or more non-transitory computer-readable media storing computer executable instructions that, when executed, cause one or more processors to perform operations comprising: receiving data associated with an input parameter and an output objective for an area domain; generating training data based at least in part on observed actions of a first agent and observed reactions of a second agent over a predetermined time period, wherein the first agent comprises a device and the second agent comprises a human user; generating, based at least in part on the training data, a conjectural model, wherein the conjectural model predicts a reaction of the second agent in response to an action of the first agent; determining, based at least in part on the output objective and the conjectural model, a conjectural action for the first agent to generate a predicted reaction from the second agent; receiving, from the device, observed data associated with the second agent; generating, based at least in part on the observed data and the output objective, an updated conjectural model; and returning to determining the conjectural action for the first agent.

B: The one or more non-transitory computer-readable media according to paragraph A, wherein the operations further comprise: generating, based at least in part on the training data, a cost model associated with the second agent, wherein the cost model determines estimated costs associated with reactions of the second agent; generating a response map using the training data; and optimizing, based at least in part on the response map, the cost model associated with the second agent.

C: The one or more non-transitory computer-readable media according to paragraph A or B, wherein generating the conjectural model comprises: generating a response map using the training data; determining a probability distribution for the observed actions and the observed reactions; and inferring parameters from the probability distribution.

D: The one or more non-transitory computer-readable media according to any of paragraphs A-C wherein: the area domain is associated with a brain-computer interface (BCI), the device comprises one or more sensors to measure neural activity, the input parameter comprises at least one of neural activity data and calibration parameters, and the output objective comprises at least one of a task performance and a target performance.

E: The one or more non-transitory computer-readable media according to any of paragraphs A-D, wherein: the area domain is associated with human-computer interface (HCI), the device comprises one or more sensors, the input parameter comprises at least one of a biometric input, a kinesthetic input, or controller characteristics, and the output objective comprises at least one of an intent-driven performance or a decrease in human workload based at least in part on decreasing an amount of user interaction.

F: The one or more non-transitory computer-readable media according to any of paragraphs A-E, wherein: the area domain is associated with an artificial intelligence (AI) assistant, the device comprises a trainer component, the human user is an operator of the device, the input parameter comprises at least one of a simulated training experience or opponent strategies, and the output objective comprises at least one of training performance or long-term learning of the operator.

G: The one or more non-transitory computer-readable media according to any of paragraphs A-F, wherein: the area domain is associated with interactive entertainment, the device comprises an adaptive AI component, the human user is a gamer, the input parameter comprises at least one of a controller input or non-player character actions, and the output objective comprises at least one of a player objective or a game objective.

H: A method comprising: receiving constant data associated with a human user; receiving input data associated with adjusting one or more control parameters of an exoskeleton device operated by the human user; generating training data by incremental changes of the one or more control parameters and by: receiving, from one or more sensors associated with the exoskeleton device, first data associated with metrics of the human user; and receiving, from the one or more sensors associated with the exoskeleton device, second data associated with motor input associated with actions of the human user generating, based at least in part on the training data, a conjectural model, wherein the conjectural model predicts a responding action of the human user in response to a change of a first control parameter, determining, using the conjectural model, a first predicted action based at least in part on the change of the first control parameter; receiving, from the one or more sensors, observed data associated with the metrics of the human user and the motor input associated with the actions of the human user determining a rate of error associated with the first predicted action and the observed data; generating, based at least in part on the observed data and the rate of error, an updated conjectural model; and returning to receiving the observed data from the one or more sensors.

I: The method according to paragraph H, further comprising: generating, based at least in part on the training data, a human cost model, wherein the human cost model estimates a predicted cost associated with an action of the human user; and generating, based at least in part on the observed data and the rate of error, an updated human cost model.

J: The method according to paragraph H or I, wherein the one or more sensors comprises one or more of a respirometer, a pedometer, a heart-rate monitor, or at least one joint torque monitor.

K: The method according to any of paragraphs H-J, wherein the constant data associated with the human user comprises one or more of an age, a height, a weight, a sex, a cadence, or a metabolic constant.

L: The method according to any of paragraphs H-K, wherein the observed data comprises an energy consumption based on a predetermined metabolic function.

M: The method according to any of paragraphs H-L, wherein adjusting the one or more control parameters comprises changing an amount of assistance provided by the exoskeleton device based at least in part on an output objective, the output objective comprising at least one of decreasing user pain and training user behavior.

N: A system comprising: one or more processors; a memory; and one or more components stored in the memory and executable by the one or more processors to perform operations comprising: receiving an output objective associated with an area domain; receiving a one or more models associated with determining an action for a first agent to predict a reaction from a second agent; determining, using the one or more models, a first action for the first agent to cause a first reaction from the second agent based at least in part on the output objective; receiving, from the first agent, observed data associated with the second agent; determining a rate of error associated with the first reaction and the observed data; and determining, using the one or more models and based at least in part on the rate of error and the output objective, a second action for the first agent to cause a second reaction from the second agent.

O: The system according to paragraph N, wherein the one or more models comprise a cost model to estimate cost associated with reactions of the second agent.

P: The system according to paragraph N or O, wherein the one or more models comprise a conjectural model to predict the first reaction of the second agent in response to the first action of the first agent.

Q: The system according to any of paragraphs N-P, wherein: the area domain is associated with computer security, the first agent is associated with a defender, the second agent is associated with an attacker, an input parameter comprises at least one of security policies or infrastructure access, and the output objective comprises at least one of finding exploits or preventing data breach.

R: The system according to any of paragraphs N-Q, wherein: the area domain is associated with autonomous vehicles, the first agent is associated with an autonomous vehicle, the second agent is associated with other vehicles, an input parameter comprises at least one of a vehicle state, acceleration, or steering, and the output objective comprises at least one of fuel usage or trip duration.

S: A method comprising: receiving, from first agents, training data associated with first observations of an environment and reactions associated with second agents; generating, based at least in part on the training data, one or more machine learning (ML) models, wherein the one or more ML models comprises a value world model and a conjectural model associated with the second agents, the conjectural model being configured to receive input observation data and output conjectural responses for the second agents; receiving, from a first agent of the first agents, data associated with second observations of the environment, wherein a portion of the data is associated with responses of a second agent of the second agents; determining, based at least in part on the data, an event probability of an environment state associated with the environment and a conjectural probability of a response associated with the second agent; determining, based at least in part on the event probability of the environment state and the conjectural probability of the response, an updated value world model and an updated conjectural model; determining, based at least in part on the updated value world model and the updated conjectural model, an action for the first agent; receiving, from the first agent, an observed response of the second agent; and returning to receiving the data from the first agent.

T: The method according to paragraph S, wherein determining the action for the first agent comprises determining optimized costs associated with actions for the first agent.

U: The method according to paragraph S or T, wherein the first agents are associated with players and the second agents are associated with opponents.

V: The method according to any of paragraphs S-U, wherein the first agents are associated with human users and the second agents are associated with at least one of a machine or an algorithm.

W: The method according to any of paragraphs S-V, wherein the data is received at real-time or near real-time.

X: The method according to any of paragraphs S-W, wherein generating the one or more ML models is based at least in part on external features associated with the training data that inform the event probability.

Y: A method comprising: performing a conjectural process with an objective associated with a first agent, the conjectural process comprising: receiving, from the first agent, data associated with observations of an environment, wherein the environment comprises a second agent; determining, based at least in part on the data, conjectural probabilities for predicted responses associated with the second agent; determining, based at least in part on the conjectural probabilities, an objective response from the predicted responses; determining, based at least in part on the objective response, at least one action of possible actions that anticipate the objective response; determining, based at least in part on the at least one action, an action for the first agent; and receiving, from the first agent, an observed response of the second agent; and repeating the conjectural process until the objective associated with the first agent is achieved.

Z: The method according to paragraph Y, further comprising: generating an action map for the first agent, wherein the action map comprises a cost analysis for the possible actions associated with the first agent, wherein the objective associated with the first agent comprises minimizing a cost associated with the action for the first agent.

AA: The method according to paragraph Y or Z, further comprising: determining a conjectural model based at least in part on the objective being achieved.

AB: The method according to any of paragraphs Y-AA, further comprising: determining a cost model based at least in part on the objective being achieved.

AC: A method comprising: receiving input data, the input data comprising an initial condition, a predetermined conjectural equilibrium (CE) tolerance, an initial depth level, a performance criteria, and a depth level tolerance; initiating conjecture variables with the input data, the conjecture variables comprising a current depth level initiated to the initial depth level, a first action profile associated with a first agent, and a second action profile associated with a second agent; repeating a CE process while the current depth level is less than the depth level tolerance and while a joint action profile between the first action profile and the second action profile is less than the predetermined CE tolerance, the CE process comprising: determining, by using a machine model and the current depth level, the joint action profile between the first action profile and the second action profile; computing the performance criteria based at least in part on the predetermined CE tolerance and the current depth level; storing the performance criteria in an array associated with the current depth level; and increasing the current depth level incrementally; determining a ranking for the performance criteria in the array; and determining an optimal depth level is associated with a first ranked performance criteria in the array.

AD: The method according to paragraph AC, wherein the initial depth level is 1 and the depth level tolerance is set to a value above 10.

AE: The method according to paragraph AC or AD, further comprising determining to use the machine model with the conjecture variables associated with the first ranked performance criteria.

AF: The method according to paragraph AE, wherein the input data comprises a performance threshold and further comprising: determining that the conjecture variables fail to satisfy the performance threshold and the depth level tolerance.

AG: The method according to paragraph AF, wherein the input data further comprise a current time period, and further comprising initiating the current time period to 1.

AH: The method according to paragraph AG, further comprising: repeating until the conjecture variables satisfy the performance threshold and the depth level tolerance: determining, using the machine model, environment data and opponent data associated with the current time period; determining, using the machine model and the current time period, batch estimates for corresponding conjecture variables; and determining to update the first action profile to decrease a first cost associated with the first agent.

AI: The method according to any of paragraphs AC-AH, wherein the input data comprises at least one initial conjecture variables, and computing, by using the machine model with the input data, an optimal strategy,

AJ: The method according to paragraph AI, wherein computing the optimal strategy comprises: randomizing the optimal strategy; and determining the conjecture variables based at least in part on using a least squares algorithm.

AK: A method comprising: collecting data associated with observations of a world, wherein the world comprises a first agent and a second agent; determining, by applying a model to the data, estimated world state data, wherein determining the estimated world state data comprises: identifying one or more time-invariant world metrics; and generating an updated value model associated with the world; determining, by applying the model to the data, estimated opponent action data, wherein determining the estimated opponent action data comprises: identifying one or more time-varying action metrics associated with the second agent; and generating an updated conjectural model associated with the second agent.

AL: The method according to paragraph AK, wherein the observations of the world comprises world metrics, first metrics comprising a first cost associated with the first agent, and second metrics comprising a second cost associated with the second agent.

AM: The method according to paragraph AL, further comprising: synthesizing individual first actions associated with the first agent to change individual second responses associated with the second agent.

AN: The method according to paragraph AM, further comprising: determining an updated strategy to optimize the first cost associated with the individual first actions and the second cost associated with the individual second responses.

AO: A computer-readable medium, e.g., a computer storage medium, having thereon computer-executable instructions, the computer-executable instructions upon execution configuring a computer to perform operations as any of paragraphs H-AN recites.

AP: A device comprising: a processor; and a computer-readable medium, e.g., a computer storage medium, having thereon computer-executable instructions, the computer-executable instructions upon execution by the processor configuring the device to perform operations as any of paragraphs A-AN recites.

AQ: A system comprising: means for processing; and means for storing having thereon computer-executable instructions, the computer-executable instructions including means to configure the system to carry out a method as any of paragraphs A-M or S-AN recites

### Closing Paragraphs

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be used for realizing implementations of the disclosure in diverse forms thereof.

As will be understood by one of ordinary skill in the art, each implementation disclosed herein can comprise, consist essentially of or consist of its particular stated element, step, or component. Thus, the terms “include” or “including” should be interpreted to recite: “comprise, consist of, or consist essentially of.” The transition term “comprise” or “comprises” means has, but is not limited to, and allows for the inclusion of unspecified elements, steps, ingredients, or components, even in major amounts. The transitional phrase “consisting of” excludes any element, step, ingredient or component not specified. The transition phrase “consisting essentially of” limits the scope of the implementation to the specified elements, steps, ingredients or components and to those that do not materially affect the implementation. As used herein, the term “based on” is equivalent to “based at least partly on,” unless otherwise specified.

Unless otherwise indicated, all numbers expressing quantities, properties, conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. When further clarity is required, the term “about” has the meaning reasonably ascribed to it by a person skilled in the art when used in conjunction with a stated numerical value or range, i.e. denoting somewhat more or somewhat less than the stated value or range, to within a range of ±20% of the stated value; ±19% of the stated value; ±18% of the stated value; ±17% of the stated value; ±16% of the stated value; ±15% of the stated value; ±14% of the stated value; ±13% of the stated value; ±12% of the stated value; ±11% of the stated value; ±10% of the stated value; ±9% of the stated value; ±8% of the stated value; ±7% of the stated value; ±6% of the stated value; ±5% of the stated value; ±4% of the stated value; ±3% of the stated value; ±2% of the stated value; or ±1% of the stated value.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing implementations (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate implementations of the disclosure and does not pose a limitation on the scope of the disclosure. No language in the specification should be construed as indicating any non-claimed element essential to the practice of implementations of the disclosure.

Groupings of alternative elements or implementations disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified, thus fulfilling the written description of all Markush groups used in the appended claims.

1. One or more non-transitory computer-readable media storing computer executable instructions that, when executed, cause one or more processors to perform operations comprising:
receiving data associated with an input parameter and an output objective for an area domain;
generating training data based at least in part on observed actions of a first agent and observed reactions of a second agent over a predetermined time period, wherein the first agent comprises a device and the second agent comprises a human user;
generating, based at least in part on the training data, a conjectural model, wherein the conjectural model predicts a reaction of the second agent in response to an action of the first agent;
determining, based at least in part on the output objective and the conjectural model, a conjectural action for the first agent to generate a predicted reaction from the second agent;
receiving, from the device, observed data associated with the second agent;
generating, based at least in part on the observed data and the output objective, an updated conjectural model; and
returning to determining the conjectural action for the first agent.

2. The one or more non-transitory computer-readable media of claim 1, wherein the operations further comprise:
generating, based at least in part on the training data, a cost model associated with the second agent, wherein the cost model determines estimated costs associated with reactions of the second agent;
generating a response map using the training data; and
optimizing, based at least in part on the response map, the cost model associated with the second agent.

3. The one or more non-transitory computer-readable media of claim 1, wherein generating the conjectural model comprises:
generating a response map using the training data;
determining a probability distribution for the observed actions and the observed reactions; and
inferring parameters from the probability distribution.

4. The one or more non-transitory computer-readable media of claim 1, wherein:
the area domain is associated with a brain-computer interface (BCI),
the device comprises one or more sensors to measure neural activity,
the input parameter comprises at least one of neural activity data and calibration parameters, and
the output objective comprises at least one of a task performance and a target performance.

5. The one or more non-transitory computer-readable media of claim 1, wherein:
the area domain is associated with human-computer interface (HCI),
the device comprises one or more sensors,
the input parameter comprises at least one of a biometric input, a kinesthetic input, or controller characteristics, and
the output objective comprises at least one of an intent-driven performance or a decrease in human workload based at least in part on decreasing an amount of user interaction.

6. The one or more non-transitory computer-readable media of claim 1, wherein:
the area domain is associated with an artificial intelligence (AI) assistant,
the device comprises a trainer component,
the human user is an operator of the device,
the input parameter comprises at least one of a simulated training experience or opponent strategies, and
the output objective comprises at least one of training performance or long-term learning of the operator.

7. The one or more non-transitory computer-readable media of claim 1, wherein:
the area domain is associated with interactive entertainment,
the device comprises an adaptive AI component,
the human user is a gamer,
the input parameter comprises at least one of a controller input or non-player character actions, and
the output objective comprises at least one of a player objective or a game objective.

8. A method comprising:
receiving constant data associated with a human user;
receiving input data associated with adjusting one or more control parameters of an exoskeleton device operated by the human user;
generating training data by incremental changes of the one or more control parameters and by:
receiving, from one or more sensors associated with the exoskeleton device, first data associated with metrics of the human user; and
receiving, from the one or more sensors associated with the exoskeleton device, second data associated with motor input associated with actions of the human user,
generating, based at least in part on the training data, a conjectural model, wherein the conjectural model predicts a responding action of the human user in response to a change of a first control parameter;
determining, using the conjectural model, a first predicted action based at least in part on the change of the first control parameter;
receiving, from the one or more sensors, observed data associated with the metrics of the human user and the motor input associated with the actions of the human user;
determining a rate of error associated with the first predicted action and the observed data;
generating, based at least in part on the observed data and the rate of error, an updated conjectural model; and
returning to receiving the observed data from the one or more sensors.

9. The method of claim 8, further comprising:
generating, based at least in part on the training data, a human cost model, wherein the human cost model estimates a predicted cost associated with an action of the human user; and
generating, based at least in part on the observed data and the rate of error, an updated human cost model.

10. The method of claim 8, wherein the one or more sensors comprises one or more of a respirometer, a pedometer, a heart-rate monitor, or at least one joint torque monitor.

11. The method of claim 8, wherein the constant data associated with the human user comprises one or more of an age, a height, a weight, a sex, a cadence, or a metabolic constant.

12. The method of claim 8, wherein the observed data comprises an energy consumption based on a predetermined metabolic function.

13. The method of claim 8, wherein adjusting the one or more control parameters comprises changing an amount of assistance provided by the exoskeleton device based at least in part on an output objective, the output objective comprising at least one of decreasing user pain and training user behavior.

14. A system comprising:
one or more processors;
a memory; and
one or more components stored in the memory and executable by the one or more processors to perform operations comprising:
receiving an output objective associated with an area domain;
receiving a one or more models associated with determining an action for a first agent to predict a reaction from a second agent;
determining, using the one or more models, a first action for the first agent to cause a first reaction from the second agent based at least in part on the output objective;
receiving, from the first agent, observed data associated with the second agent;
determining a rate of error associated with the first reaction and the observed data; and
determining, using the one or more models and based at least in part on the rate of error and the output objective, a second action for the first agent to cause a second reaction from the second agent.

15. The system of claim 14, wherein the one or more models comprise a cost model to estimate cost associated with reactions of the second agent.

16. The system of claim 14, wherein the one or more models comprise a conjectural model to predict the first reaction of the second agent in response to the first action of the first agent.

17. The system of claim 14, wherein:
the area domain is associated with computer security,
the first agent is associated with a defender,
the second agent is associated with an attacker,
an input parameter comprises at least one of security policies or infrastructure access, and
the output objective comprises at least one of finding exploits or preventing data breach.

18. The system of claim 14, wherein:
the area domain is associated with autonomous vehicles,
the first agent is associated with an autonomous vehicle,
the second agent is associated with other vehicles,
an input parameter comprises at least one of a vehicle state, acceleration, or steering, and
the output objective comprises at least one of fuel usage or tip duration.

19. A method comprising:
receiving, from first agents, training data associated with first observations of an environment and reactions associated with second agents;
generating, based at least in part on the training data, one or more machine learning (ML) models, wherein the one or more ML models comprises a value world model and a conjectural model associated with the second agents, the conjectural model being configured to receive input observation data and output conjectural responses for the second agents;
receiving, from a first agent of the first agents, data associated with second observations of the environment, wherein a portion of the data is associated with responses of a second agent of the second agents;
determining, based at least in part on the data, an event probability of an environment state associated with the environment and a conjectural probability of a response associated with the second agent;
determining, based at least in part on the event probability of the environment state and the conjectural probability of the response, an updated value world model and an updated conjectural model;
determining, based at least in part on the updated value world model and the updated conjectural model, an action for the first agent;
receiving, from the first agent, an observed response of the second agent; and
returning to receiving the data from the first agent.

20. The method of claim 19, wherein determining the action for the first agent comprises determining optimized costs associated with actions for the first agent.

21. The method of claim 19, wherein the first agents are associated with players and the second agents are associated with opponents.

22. The method of claim 19, wherein the first agents are associated with human users and the second agents are associated with at least one of a machine or an algorithm.

23. The method of claim 19, wherein the data is received at real-time or near real-time.

24. The method of claim 19, wherein generating the one or more ML models is based at least in part on external features associated with the training data that inform the event probability.

25. A method comprising:
performing a conjectural process with an objective associated with a first agent, the conjectural process comprising:
receiving, from the first agent, data associated with observations of an environment, wherein the environment comprises a second agent;
determining, based at least in part on the data, conjectural probabilities for predicted responses associated with the second agent;
determining, based at least in part on the conjectural probabilities, an objective response from the predicted responses;
determining, based at least in part on the objective response, at least one action of possible actions that anticipate the objective response;
determining, based at least in part on the at least one action, an action for the first agent; and
receiving, from the first agent, an observed response of the second agent; and
repeating the conjectural process until the objective associated with the first agent is achieved.

26. The method of claim 25, further comprising:
generating an action map for the first agent, wherein the action map comprises a cost analysis for the possible actions associated with the first agent, wherein the objective associated with the first agent comprises minimizing a cost associated with the action for the first agent.

27. The method of claim 25, further comprising:
determining a conjectural model based at least in part on the objective being achieved.

28. The method of claim 25, further comprising:
determining a cost model based at least in part on the objective being achieved.

29. A method comprising:
receiving input data, the input data comprising an initial condition, a predetermined conjectural equilibrium (CE) tolerance, an initial depth level, a performance criteria, and a depth level tolerance;
initiating conjecture variables with the input data, the conjecture variables comprising a current depth level initiated to the initial depth level, a first action profile associated with a first agent, and a second action profile associated with a second agent;
repeating a CE process while the current depth level is less than the depth level tolerance and while a joint action profile between the first action profile and the second action profile is less than the predetermined CE tolerance, the CE process comprising:
determining, by using a machine model and the current depth level, the joint action profile between the first action profile and the second action profile;
computing the performance criteria based at least in part on the predetermined CE tolerance and the current depth level;
storing the performance criteria in an array associated with the current depth level; and
increasing the current depth level incrementally;
determining a ranking for the performance criteria in the array; and
determining an optimal depth level is associated with a first ranked performance criteria in the array.

30. The method of claim 29, wherein the initial depth level is 1 and the depth level tolerance is set to a value above 10.

31. The method of claim 29, further comprising determining to use the machine model with the conjecture variables associated with the first ranked performance criteria.

32. The method of claim 31, wherein the input data comprises a performance threshold and further comprising:
determining that the conjecture variables fail to satisfy the performance threshold and the depth level tolerance.

33. The method of claim 32, wherein the input data further comprise a current time period, and further comprising initiating the current time period to 1.

34. The method of claim 33, further comprising:
repeating until the conjecture variables satisfy the performance threshold and the depth level tolerance:
determining, using the machine model, environment data and opponent data associated with the current time period;
determining, using the machine model and the current time period, batch estimates for corresponding conjecture variables; and
determining to update the first action profile to decrease a first cost associated with the first agent.

35. The method of claim 29, wherein the input data comprises at least one initial conjecture variables, and computing, by using the machine model with the input data, an optimal strategy,

36. The method of claim 35, wherein computing the optimal strategy comprises:
randomizing the optimal strategy; and
determining the conjecture variables based at least in part on using a least squares algorithm.

37. A method comprising:
collecting data associated with observations of a world, wherein the world comprises a first agent and a second agent;
determining, by applying a model to the data, estimated world state data, wherein determining the estimated world state data comprises:
identifying one or more time-invariant world metrics; and
generating an updated value model associated with the world;
determining, by applying the model to the data, estimated opponent action data, wherein determining the estimated opponent action data comprises:
identifying one or more time-varying action metrics associated with the second agent; and
generating an updated conjectural model associated with the second agent.

38. The method of claim 37, wherein the observations of the world comprises world metrics, first metrics comprising a first cost associated with the first agent, and second metrics comprising a second cost associated with the second agent.

39. The method of claim 38, further comprising:
synthesizing individual first actions associated with the first agent to change individual second responses associated with the second agent.

40. The method of claim 39, further comprising:
determining an updated strategy to optimize the first cost associated with the individual first actions and the second cost associated with the individual second responses.
